(19) United States
(12) Patent Application Publication
(10) Pub. No.: US 2026/0029696 A1
(43) Pub. Date: Jan. 29, 2026

(54) PROJECTOR

(71) Applicant: SEIKO EPSON CORPORATION, Tokyo (JP)

(72) Inventors: Takuo YONEYAMA, AZUMINO-SHI (JP); Kazuhisa MIZUSAKO, SHIOJIRI-SHI (JP)

(21) Appl. No.: 19/282,065

(22) Filed: Jul. 28, 2025

(30) Foreign Application Priority Data
Jul. 29, 2024 (JP) 2024-122179

(51) Int. Cl. G03B 21/00; G03B 21/20

(52) U.S. Cl. CPC G03B 21/006; G03B 21/2006

(57) ABSTRACT

A projector according to the present disclosure includes a light source device configured to periodically emit illumination light including a first light and a second light; a light modulation device configured to modulate the illumination light emitted from the light source device; and a projection optical system configured to project image light emitted from the light modulation device. An irradiation cycle of the second light irradiated from the light source device and irradiated on the second liquid crystal element and an image forming cycle of the second liquid crystal element are synchronized, the image forming cycle of the first liquid crystal element and the image forming cycle of the second liquid crystal element are shifted, and a wavelength of the first light incident on the first liquid crystal element is different from a wavelength of the second light incident on the second liquid crystal element.

The present application is based on, and claims priority from JP Application Serial Number 2024-122179, filed Jul. 29, 2024, the disclosure of which is hereby incorporated by reference herein in its entirety.

### BACKGROUND

### 1. Technical Field

The present disclosure relates to a projector.

### 2. Related Art

As a projector, which is an image display device, a device has been proposed in which illumination light emitted from a light source device is temporally scanned over a modulation surface of a light modulation device such as a liquid crystal panel to illuminate the light modulation device with color light and the image light emitted from the light modulation device is projected onto a projection surface such as a screen by a projection optical system.

For example, JP-A-2011-221500 discloses a projector in which a black display period is set in an image forming cycle of a vertical synchronization signal along a scanning direction in which liquid crystal panel illumination light of a light modulation device is scanned. That is, in the projector disclosed in JP-A-2011-221500, the output of a light emitting element of a light source device is controlled to be turned off during a period corresponding to at least one or more subframes among periods corresponding to a plurality of subframes of the light modulation device.

In the projector in the related art including the projector disclosed in JP-A-2011-221500, for example, when a single-plate type or a two-plate type configuration is adopted, it is easy to reduce the size, reduce the weight, and simplify the configuration compared to a three-plate type configuration. However, in the single-plate or the two-plate type configuration, since color mixture occurs in the projection image with time, even when a drive frequency related to the image forming period in the plurality of color regions of the liquid crystal panel of the light modulation device is set to be equal to or higher than a critical fusion frequency (CFF), when an observer of the projection image observes the projection image with high-speed eye movement such as a saccade, separation of the image light of the plurality of colors corresponding to the respective color regions may be visually recognized or perceived. The phenomenon in which the color light is visually recognized or perceived is called color breakup.

In the projector in the related art, when the black display period is provided in each pixel of the liquid crystal panel of the light modulation device, there is a possibility that color breakup occurs, and thus, a countermeasure for suppressing the occurrence of color breakup is desired.

### SUMMARY

A projector according to one aspect of the present disclosure includes a light source device configured to periodically emit illumination light including a first light and a second light; a light modulation device configured to modulate the illumination light emitted from the light source device in accordance with image information; and a projection optical system configured to project image light emitted from the light modulation device, wherein the light source device has a light emitting element configured to emit the first light and the second light, the light modulation device has a first liquid crystal element configured to form an image by converting the first light incident thereon into a first image light in accordance with the image information input thereto and a second liquid crystal element configured to form an image by converting the second light incident thereon into a second image light in accordance with the image information input thereto, an irradiation cycle of the first light irradiated from the light source device and irradiated on the first liquid crystal element and an image forming cycle of the first liquid crystal element are synchronized with each other, an irradiation cycle of the second light irradiated from the light source device and irradiated on the second liquid crystal element and an image forming cycle of the second liquid crystal element are synchronized with each other, the image forming cycle of the first liquid crystal element and the image forming cycle of the second liquid crystal element are shifted from each other, and a wavelength of the first light incident on the first liquid crystal element and a wavelength of the second light incident on the second liquid crystal element are different from each other.

### BRIEF DESCRIPTION OF THE DRAWINGS

FIG. 1 is a schematic view of a projector according to a first embodiment.

FIG. 2 is a schematic view for explaining the behavior of a light scanning device of the projector shown in FIG. 1.

FIG. 3 is a schematic view for explaining the behavior of the light scanning device of the projector shown in FIG. 1.

FIG. 4 is a schematic view for explaining the behavior of the light scanning device of the projector shown in FIG. 1.

FIG. 5 is a time chart relating to the operation of a light source device, and the liquid crystal panel of one light modulation device of the projector in FIG. 1.

FIG. 6 is a time chart relating to the operations of the light source device, and the liquid crystal panel of the one light modulation device in the divided region of the modulation surface of one light modulation device of the projector of FIG. 1.

FIG. 7 is a schematic view showing an example of the distribution of color regions on a modulation surface of the one light modulation device and in a projection image in the projector of FIG. 1.

FIG. 8 is a time chart related to the operations of the light source device, and the liquid crystal panels of the two light modulation devices of the projector of FIG. 1.

FIG. 9 is another time chart related to the operations of the light source device, and the liquid crystal panels of the two light modulation devices of the projector of FIG. 1.

FIG. 10 is a flowchart related to a control performed by a control section of the projector in FIG. 1.

FIG. 11 is a schematic view of a light source device of a projector according to a modification of the first embodiment.

FIG. 12 is a schematic view of a projector according to a second embodiment.

FIG. 13 is a schematic diagram of a light source device of a projector according to a modification of the second embodiment.

FIG. 14 is a schematic view of a projector according to a third embodiment.

### DESCRIPTION OF EMBODIMENTS

In the drawings referred to below, the scale of dimensions may be changed depending on the components in order to make the components easy to see.

### First Embodiment

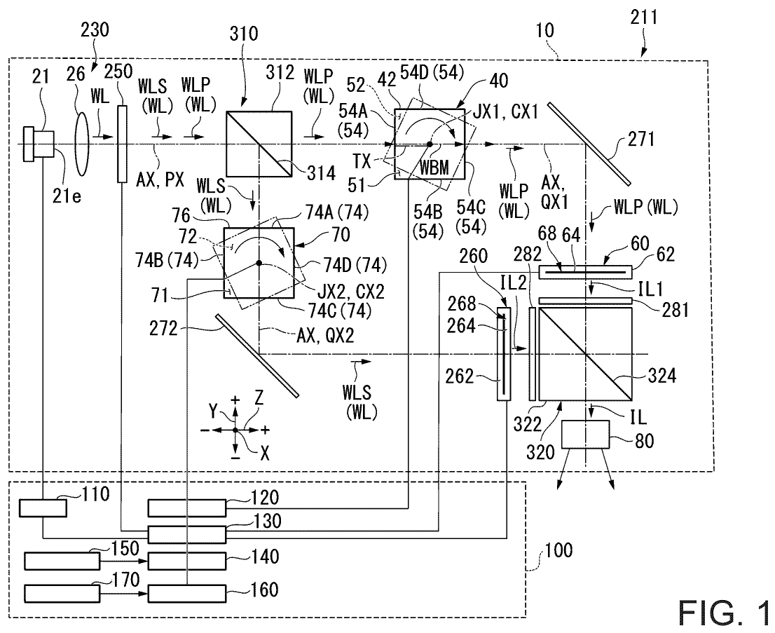

First, a first embodiment of the present disclosure will be described with reference to FIG. 1 to FIG. 10.

First, a basic configuration of a projector 201 according to the first embodiment of the present disclosure will be described. FIG. 1 is a schematic view of the projector 201. The projector 201 is a two-plate type image display device including two liquid crystal panels as light modulation devices. As shown in FIG. 1, a projector 211 includes a light source device 230, a polarizing separation element 310, a light scanning device 40, a reflective element 271, a light modulation device 60, a polarizing plate 281, a light scanning device 70, a reflective element 272, a light modulation device 260, a polarizing plate 282, a polarizing separation element 320, a projection optical system 80, a light source output control device 110, a rotation control device 120, a drive control device 130, a central processing unit 140, a user interface 150, a video processing circuit 160, and a video interface 170.

The light source device 230 has a light emitting element 21, a collimating lens 26, and a spatial light modulator 250. The light emitting element 21 periodically switches and emits red light RL, green light GL, and blue light BL included in white light. The red light RL, the green light GL, or the blue light BL emitted from the light emitting element 21 is described and shown as color light WL. The color light WL corresponds to the illumination light described in claims (to be described later). The color light WL emitted from the light emitting element 21 is S-polarization light or P-polarization light, and is, for example, S-polarization light.

In the following description, an axis parallel to an optical axis AX and a principal ray of the color light WL, which is emitted from the light emitting element 21, is set as a Z-axis, one side in a direction parallel to the Z-axis is set as a −Z side, and the other side in the direction parallel to the Z-axis is set as a +Z side. One axis orthogonal to the Z-axis is set as an X-axis, one side in a direction parallel to the X-axis is defined as a −X side, and the other side in the direction parallel to the X-axis is defined as a +X side. An axis orthogonal to the Z-axis and the X-axis is set as a Y-axis, one side in a direction parallel to the Y-axis is set as a −Y side, and the other side in the direction parallel to the Y-axis is defined as a +Y side.

The light emitting element 21 emits the color light WL from an emitting surface 21e to the +Z side along the Z-axis. The light emitting element 21 is, for example, a white laser diode (LD) in which a red LD, a green LD, and a blue LD are integrated.

The collimating lens 26 is disposed in an optical path of the color light WL emitted from the light emitting element 21, and is disposed on the +Z side with respect to the emitting surface 21e of the light emitting element 21. A central axis of the collimating lens 26 overlaps the optical axis AX.

The collimating lens 26 emits the color light WL emitted from the light emitting element 21 along the optical axis AX as parallel light parallel to the Z-axis. The collimating lens 26 is, for example, a biconvex lens. Note that the collimating lens 26 may be a plano-convex lens having a flat incident surface parallel to an XY plane including the X-axis and the Y-axis and an emitting surface convex to the +Z side. Although the collimating lens 26 is disposed away from the emitting surface 21e of the light emitting element 21 in FIG. 1, the collimating lens 26 is a plano-convex lens, the collimating lens 26 may be in contact with the emitting surface 21e of the light emitting element 21.

The spatial light modulator 250 is disposed in the optical path of the color light WL emitted from the collimating lens 26, substantially overlaps the collimating lens 26 in the X-axis and the Y-axis, and is disposed on the +Z side of the collimating lens 26. The color light WL emitted from the collimating lens 26 is incident on the spatial light modulator 250 from the −Z side.

The polarization of the color light WL incident on the spatial light modulator 250 from the collimating lens 26 is converted into different polarization light at a predetermined polarization switching cycle. The S-polarization light of the color light WL incident on the spatial light modulator 250 from the collimating lens 26 is converted into P-polarization light at the predetermined polarization switching cycle. That is, the spatial light modulator 250 alternately emits color light WLP as the P-polarization light and color light WLS as the S-polarization light in time series in the predetermined polarization switching cycle. The color light WLP, which is the P-polarization light, corresponds to a first light in the claims (to be described later). The color light WLS, which is the S-polarization light, corresponds to a second light (to be described later).

The polarizing separation element 310 is disposed in the optical paths of the color light WLP and WLS periodically emitted in time series from the spatial light modulator 250 of the light source device 230, overlaps the modulation surface of the spatial light modulator 250 in the X-axis and the Y-axis, and is disposed on the +Z side of the spatial light modulator 250. The polarizing separation element 310 corresponds to a first polarizing separation element (to be described later).

The polarizing separation element 310 is, for example, a cube type polarizing beam splitter 312. The polarizing beam splitter 312 has a reflective film 314 that transmits one type of polarized light of the color light WL and reflects the other type of polarized light of the color light WL. The reflective film 314 in the polarizing beam splitter 312 inclines from the +Y side to the −Y side with respect to the optical axis AX in accordance with movement from the −Z side to the +Z side. The reflective film 314 transmits the color light WLP and reflects the color light WLS, for example. The polarizing separation element 310 may be a plate type polarizing beam splitter having the reflective film 314.

The polarizing separation element 310 periodically emits the color light WLP to the +Z side along the Z-axis in accordance with the polarization switching cycle described above. The polarizing separation element 310 also periodically emits the color light WLS to the −Y side along the Y-axis in accordance with the polarization switching cycle described above. In a period in which the color light WLP is emitted from the polarizing separation element 310 to the +Z side along the Z-axis, the color light WLS is not emitted from the polarizing separation element 310 to the −Y side along the Y-axis. Similarly, in a period in which the color light WLS is emitted from the polarizing separation element 310 to the −Y side along the Y-axis, the color light WLP is not emitted from the polarizing separation element 310 to the +Z side along the Z-axis.

The light scanning device 40 is disposed in the optical path of the color light WLP emitted from the polarizing separation element 310, substantially overlaps the polarizing separation element 310 in the X-axis and the Y-axis, and is disposed on the +Z side of the polarizing separation element 310. The light scanning device 40 scans, in the XY plane, the color light WLP that is emitted from the light source device 230 and that is separated by the polarizing separation element 310.

The light scanning device 40 has a translucent member 42 and a rotating device such as a motor (not shown). The translucent member 42 corresponds to a transmissive optical element (to be described later). The translucent member 42 is disposed in the optical path of the white color light WL emitted from the light source device 230 and is disposed on the +Z side of the light source device 230. The translucent member 42 is formed in a columnar shape. A central axis JX1 of the translucent member 42 is parallel to the X-axis and intersects the optical axis AX of the color light WLP or passes through the vicinity of the optical axis AX of the color light WLP.

The translucent member 42 is a polygonal column having the central axis JX1. The translucent member 42 has two end surfaces 51 and 52, which intersect the central axis JX1 and which are parallel to a YZ plane including the Y-axis and the Z-axis, and a plurality of side surfaces 54. The end surfaces 51 and 52 correspond to a first surface (to be described later). The end surface 51 is disposed relatively on the +X side. The end surface 52 is disposed on the −X side of the end surface 51 and overlaps the end surface 51 as viewed along the X-axis. The end surfaces 51 and 52 have a polygonal shape centered on the central axis JX1. The plurality of side surfaces 54 correspond to an incident surface, an emitting surface, and a second surface (to be described later).

The number of the side surfaces 54 is the same as the number of corners and the number of edges of the end surfaces 51 and 52. The side surfaces 54 connect the outer peripheral edges of the end surface 51 to the outer peripheral edges of the end surface 52 that overlap with the outer peripheral edges of the end surface 51 as viewed along the X-axis.

The end surfaces 51 and 52 have, for example, a regular quadrangular shape and have the same shape, size, and area as each other. The translucent member 42 has two end surfaces 51 and 52 and four side surfaces 54A, 54B, 54C, and 54D. The side surfaces 54A, 54B, 54C, and 54D have the same size and area. The sizes and areas of the side surfaces 54A, 54B, 54C, and 54D are appropriately larger than the irradiation area centered on the optical axis AX of the color light WLP irradiated from the polarizing separation element 310 according to the scanning region of the color light WLP as will be described later.

As viewed along the X-axis, the side surfaces 54A and 54C are opposed to each other with the central axis JX1 interposed therebetween and are parallel to each other. The side surfaces 54B and 54D are opposed to each other with the central axis JX1 interposed therebetween and are parallel to each other. In the present specification, the two side surfaces 54 being parallel to each other means that the angle formed by the two side surfaces 54 is within a range of 0° to 5° in consideration of the processing accuracy of the material of the translucent member 42, the allowable range of the parallelism of the color light WLP, and the like.

The translucent member 42 is disposed in a state of being rotatable around the central axis JX1. The central axis JX1 corresponds to a rotation axis CX1 of the translucent member 42. While rotating around the rotation axis CX1, the translucent member 42 transmits the color light WLP incident from the −Z side along the Z-axis and the optical axis AX and emits the color light WLP to the +Z side.

In the present specification, a state in which the translucent member 42 is rotating around the rotation axis CX1 may be referred to as a rotation state. In the rotation state of the translucent member 42, the side surface 54 on which the color light WLP emitted from the light source device 230 and separated by the polarizing separation element 310 is incident on the translucent member 42 is not fixed to one of the four side surfaces 54A, 54B, 54C, and 54D, but is one or two of the four side surfaces 54A, 54B, 54C, and 54D, and changes depending in time t.

Note that the number of the side surfaces 54 of the translucent member 42 is not limited to four, and is desirably 2×m (m is a natural number equal to or greater than 2). When the number of the side surfaces 54 is an even number of four or more, all the side surfaces 54 are parallel to the opposed side surfaces 54, the generation of a stray light of the color light WLP transmitted through the translucent member 42 is suppressed, and the light use efficiency in the projector 211 is improved.

The material of the translucent member 42 is a material having a light-transmissive property with respect to the color light WL and is any of optical glasses such as BK7, which is borosilicate crown glass, or B270, which is high transparency crown glass, quartzes, transparent resins, and the like.

The reflective element 271 is disposed in the optical path of the color light WLP emitted from the translucent member 42 of the light scanning device 40 and within the region scanned by the color light WLP, and is disposed on the +Z side of the translucent member 42. The reflective element 271 is a mirror having a reflective surface that inclines from the +Y side to the −Y side in accordance with movement from the −Z side to the +Z side. The reflective surface of the reflective element 271 regularly reflects the color light WLP, which is emitted from the translucent member 42, is incident from the −Z side, and emits the color light WLP to the −Y side.

The light modulation device 60 is disposed in the optical path of the color light WLP emitted from the reflective element 271 and within the region scanned with the color light WLP. The light modulation device 60 overlaps the reflective element 271 in the X-axis and the Z-axis and is disposed on the −Y side of the reflective element 271. The region on the XY plane that can be irradiated with the color light WLP by scanning the color light WLP by the translucent member 42 of the light scanning device 40 is converted into a region on the XZ plane including the X-axis and the Z-axis of the light modulation device 60 by the reflective element 271.

The light modulation device 60 has a modulation surface 64 parallel to the XZ plane. The position, size, area, and shape of the modulation surface 64 on the XZ plane are equivalent to the region on the XZ plane that can be irradiated with the color light WLP by scanning the color light WLP by the translucent member 42 as described above and are equivalent to the range in which the irradiation region of the color light WLP on the XZ plane and an appropriate margin region is secured outside the irradiation region.

The light modulation device 60 modulates the color light WLP incident from the +Y side by the reflective element 271 by an electrical signal input from the drive control device 130 as described later in accordance with image information of a projection target and converts the color light WLP into image light IL1. The image light IL1 corresponds to first image light (to be described later).

The light modulation device 60 is, for example, a transmissive liquid crystal panel 62. The liquid crystal panel 62 corresponds to a first liquid crystal element (to be described later). The liquid crystal panel 62 constituting the light modulation device 60 has a plurality of pixels two dimensionally arranged along the X-axis and the Z-axis in the XZ plane. The plurality of pixels of the liquid crystal panel 62 constitute the modulation surface 64.

The plurality of pixels of the liquid crystal panel 62 include an element substrate, a counter substrate, and a liquid crystal layer 68 interposed between the element substrate and the counter substrate in the Y-axis, which are not shown. The switching element is provided on, for example, the element substrate. The switching element is, for example, a polysilicon thin film transistor (TFT). The switching element of each pixel is supplied, from the drive control device 130, with the electrical signal corresponding to the brightness and the light amount of each of the red light, the green light, and the blue light at the relative position of each pixel of the image information on the modulation surface 64 of the light modulation device 60 in an image of a projection target projected by the projector 211.

Each pixel of the liquid crystal panel 62 modulates a vibration direction of any one of the red light, the green light, and the blue light included in the color light WLP by the liquid crystal layer 68 by the operation of the switching elements according to the electrical signal described above, generates red-color image light, green-color image light, and blue-color image light, and emits the image light IL1 according to the light amount ratio of the three colors. The light modulation device 60 emits the image light IL1 generated by the liquid crystal panel 62 to the −Y side along the optical axis AX and the Y-axis.

Each pixel of the liquid crystal panel 62 has a color filter (not shown) of red color, green color, or blue color. Therefore, the light modulation device 60 emits the image light IL1 of full color that can be generated by the red-color image light, the green-color image light, and the blue-color image light. The projector 211 can perform full-color display.

The driving method of the liquid crystal panel 62 is not particularly limited, but is, for example, a twisted nematic (TN) method, a vertical alignment (VA) method, or an in-plane switching (IPS) method.

The polarizing plate 281 is disposed in the optical path of the image light IL1 emitted from the light modulation device 60, overlaps the light modulation device 60 in the X-axis and the Z-axis, and is disposed on the −Y side of the light modulation device 60.

The polarizing plate 281 transmits specific linearly polarized light of the image light IL1 emitted from the light modulation device 60 and absorbs or reflects polarized components other than the specific linearly polarized light. The polarizing plate 281 transmits and emits, for example, the P-polarization light among the image light IL1 to the −Y side and absorbs or reflects polarized light other than the P-polarization light among the image light IL1. When an absorption type polarizing plate is used as the polarizing plate 281, return light due to the polarized light other than the P-polarization light emitted from the polarizing plate 281 to the −Z side is reduced, the generation of stray light in the projector 211 is suppressed, and the light use efficiency is improved.

The light scanning device 70 is disposed in the optical path of the color light WLS emitted from the polarizing separation element 310, substantially overlaps the polarizing separation element 310 in the X-axis and the Z-axis, is disposed on the −Y side of the polarizing separation element 310, and is disposed on the +Y side of the light modulation device 60 and the polarizing plate 281. The light scanning device 70 scans the color light WLP, which is emitted from the light source device 230 and is separated by the polarizing separation element 310, in the XZ plane.

The light scanning device 70 has a translucent member 76 and a rotating device such as a motor (not shown). The translucent member 76 corresponds to the transmissive optical element (to be described later). The translucent member 76 is disposed in the optical path of the color light WLS emitted from the polarizing separation element 310 and is disposed on the −Y side of the polarizing separation element 310. The translucent member 76 is formed in a columnar shape. A central axis JX2 of the translucent member 76 is parallel to the X-axis and intersects the optical axis AX of the color light WLS or passes through the vicinity of the optical axis AX of the color light WLS.

The translucent member 76 is a polygonal column having the central axis JX2. The translucent member 76 has two end surfaces 71 and 72, which intersect the central axis JX2 and are parallel to the YZ plane, and a plurality of side surfaces 74. The end surfaces 71 and 72 correspond to the first surface (to be described later). The end surface 71 is disposed relatively on the +X side. The end surface 72 is disposed on the −X side of the end surface 51 and overlaps the end surface 51 as viewed along the X-axis. The end surfaces 71 and 72 have a polygonal shape centered on the central axis JX2. The plurality of side surfaces 74 correspond to the incident surface, the emitting surface, and the second surface (to be described later).

The number of the side surfaces 74 is the same as the number of corners and the number of edges of the end surfaces 71 and 72. The side surface 74 connects each of outer peripheral edges of the end surface 71 to outer peripheral edge of the end surface 72 that overlaps with the outer peripheral edge of the end surface 71 as viewed along the X-axis.

The end surfaces 71 and 72 have, for example, a regular quadrangular shape, and have the same shape, size, and area as each other. The translucent member 76 has two end surfaces 71 and 72 and four side surfaces 74A, 74B, 74C, and 74D. The side surfaces 74A, 74B, 74C, and 74D have the same size and area. The sizes and areas of the side surfaces 74A, 74B, 74C, and 74D are appropriately larger than the irradiation areas centered on the optical axis AX of the color light WLS irradiated from the polarizing separation element 310 according to the scanning region of the color light WLS as will be described later.

As viewed along the X-axis, the side surfaces 74A and 74C are opposed to each other with the central axis JX2 interposed therebetween and are parallel to each other. The side surfaces 74B and 74D are opposed to each other with the central axis JX2 interposed therebetween and are parallel to each other. In the present specification, the two side surfaces 74 being parallel to each other means that the angle formed by the two side surfaces 74 is within a range of 0° to 5° in consideration of the processing accuracy of the material of the translucent member 76, the allowable range of the parallelism of the color light WLS, and the like.

The translucent member 76 is disposed in a state of being rotatable around the central axis JX2. The central axis JX2 corresponds to a rotation axis CX2 of the translucent member 76. The translucent member 76 transmits, while rotating around the rotation axis CX2, the color light WLS incident from the +Y side along the Y-axis and the optical axis AX and emits the color light WLS to the −Y side.

In the present specification, a state in which the translucent member 76 is rotating around the rotation axis CX2 may also be referred to as a rotation state. In the rotation state of the translucent member 76, the side surface 74 on which the color light WLS emitted from the light source device 230 and separated by the polarizing separation element 310 is incident on the translucent member 76 is not fixed to one of the four side surfaces 74A, 74B, 74C, and 74D, but is one or two of the four side surfaces 74A, 74B, 74C, and 74D, and changes depending in time t.

Note that the number of the side surfaces 74 of the translucent member 76 is not limited to four, and is preferably 2×m (m is a natural number equal to or greater than 2). When the number of the side surfaces 74 is an even number of four or more, all the side surfaces 74 are parallel to the opposed side surfaces 74, the generation of stray light of the color light WLS transmitted through the translucent member 76 is suppressed, and the light use efficiency in the projector 211 is improved.

The material of the translucent member 76 is a material having a light-transmissive property with respect to the color light WL, similarly to the material of the translucent member 42, and is any of optical glasses such as BK7, which is borosilicate crown glass, or B270, which is high transparency crown glass, quartzes, transparent resins, and the like.

The reflective element 272 is disposed in the optical path of the color light WLS emitted from the translucent member 76 of the light scanning device 70 and within the region scanned by the color light WLS, is disposed on the −Y side of the translucent member 76, and is disposed on the −Y side of the light modulation device 60 and the polarizing plate 281. The reflective element 272 is a mirror having a reflective surface that inclines from +Y side to the −Y side in accordance with movement from the −Z side to +Z side. The reflective surface of the reflective element 272 regularly reflects the color light WLS, which is emitted from the translucent member 76 and which is incident from the +Y side, and emits the color light WLS to the +Z side.

The light modulation device 260 is disposed in the optical path of the color light WLS emitted from the reflective element 272 and within the region scanned with the color light WLS. The light modulation device 260 overlaps the reflective element 272 in the X-axis and the Z-axis and is disposed on the +Z side of the reflective element 272. The region on the XZ plane that can be irradiated with the color light WLS by scanning the color light WLS by the translucent member 76 of the light scanning device 70 is converted into a region on the XY plane of the light modulation device 260 by the reflective element 272.

The light modulation device 260 has a modulation surface 264 parallel to the XY plane. The position, size, area, and shape of the modulation surface 264 on the XY plane are equivalent to the region on the XY plane that can be irradiated with the color light WLS by scanning the color light WLS by the translucent member 76 as described above and are equivalent to the range in which the irradiation region of the color light WLS on the XY plane and an appropriate margin region is secured outside the irradiation region.

The light modulation device 260 modulates the color light WLS incident from the −Z side by the reflective element 272 by an electrical signal input from the drive control device 130 as described later in accordance with the image information of a projection target and converts the color light WLS into image light IL2. The image light IL2 corresponds to second image light (to be described later).

The light modulation device 260 is, for example, a transmissive liquid crystal panel 262. The liquid crystal panel 262 corresponds to a second liquid crystal element (to be described later). The liquid crystal panel 262 constituting the light modulation device 260 has a plurality of pixels two dimensionally arranged along the X-axis and the Y-axis in the XY plane. The plurality of pixels of the liquid crystal panel 262 constitute the modulation surface 264.

The plurality of pixels of the liquid crystal panel 262 include an element substrate, a counter substrate, and a liquid crystal layer 268 interposed between the element substrate and the counter substrate in the Z-axis, which are not shown. The switching element is provided on, for example, the element substrate. The switching element is, for example, a TFT. The switching element of each pixel is supplied, from the drive control device 130, with electrical signals corresponding to the brightness and the light amount of each of the red light, the green light, and the blue light at the relative position of each pixel of the image information on the modulation surface 264 of the light modulation device 260 in the image of the projection target projected by the projector 211.

Each pixel of the liquid crystal panel 262 modulates the vibration direction of any one of the red light, green light, and blue light included in the color light WLS by the liquid crystal layer 268 by the operation of the switching elements according to the electrical signals described above, generates the red-color image light, the green-color image light, and the blue-color image light, and emits the image light IL2 according to the light amount ratio of the three colors. The light modulation device 260 emits the image light IL2 generated by the liquid crystal panel 262 to the +Z side along the optical axis AX and the Z-axis.

Each pixel of the liquid crystal panel 262 has a color filter (not shown) of red color, green color, or blue color. Therefore, the light modulation device 260 emits the full-color image light IL2 that can be generated by the red-color image light, the green-color image light, and the blue-color image light. The projector 211 can perform full-color display.

Each pixel of the liquid crystal panel 62 of the light modulation device 60 and each pixel of the liquid crystal panel 262 of the light modulation device 260 may not has a color filter. In that case, when any one of the color light of red light, green light, or blue light is emitted from the light emitting element 21 of the light source device 230, the light modulation devices 60 and 260 emit the monochromatic image light IL1 and IL2 corresponding to any one type of color light. In a case where each pixel of the liquid crystal panels 62 and 262 does not have a color filter, the projector 211 can perform monochrome display.

The driving method of the liquid crystal panel 262 is not particularly limited, but is, for example, the TN method, the VA method, or the IPS method, similarly to the driving method of the liquid crystal panel 62.

The polarizing plate 282 is disposed in the optical path of the image light IL2 emitted from the light modulation device 260, overlaps the light modulation device 260 in the X-axis and the Y-axis, and is disposed on the +Z side of the light modulation device 260.

The polarizing plate 282 transmits specific linearly polarized light of the image light IL2 emitted from the light modulation device 260 and absorbs or reflects polarized components other than the specific linearly polarized light. The polarizing plate 282 transmits and emits, for example, the S-polarization light among the image light IL2 to the +Z side and absorbs or reflects polarized light other than the S-polarization light among the image light IL2. When an absorption type polarizing plate is used as the polarizing plate 282, return light due to the polarized light other than the S-polarization light emitted from the polarizing plate 282 to the −Z side is reduced, the generation of stray light in the projector 211 is suppressed, and the light use efficiency is improved.

The polarizing separation element 320 is disposed in a region where the light path of the image light IL1 periodically emitted in time series from the liquid crystal panel 62 of the light modulation device 60 and the light path of the image light IL2 periodically emitted in time series from the liquid crystal panel 262 of the light modulation device 260 overlap each other. The polarizing separation element 320 overlaps the liquid crystal panel 62 in the X-axis and the Z-axis, is disposed on the −Y side of the liquid crystal panel 62, overlaps the liquid crystal panel 262 in the X-axis and the Y-axis, and is disposed on the +Z side of the liquid crystal panel 262. The polarizing separation element 320 corresponds to a second polarizing separation element (to be described later). The polarizing separation element 320 is a beam synthesis element for superimposing the image light IL1 and IL2 on the light path along the same direction.

The polarizing separation element 320 is, for example, a cube type polarizing beam splitter 322. The polarizing beam splitter 322 has a reflective film 324 that transmits one type of polarized light of the color light WL and reflects the other type of polarized light of the color light WL. The reflective film 324 in the polarizing beam splitter 322 inclines, with respect to the optical axis AX of the image light IL1 and the optical axis AX of the image light IL2, from +Y side to the −Y side in accordance with movement from the −Z side to +Z side. The reflective film 324 transmits the color light WLP and reflects the color light WLS, for example. The polarizing separation element 320 may be a plate type polarizing beam splitter having the reflective film 324.

The polarizing separation element 320 periodically emits the color light WLP to the −Y side along the Y-axis according to the polarization switching cycle described above. The polarizing separation element 320 also periodically emits the color light WLS to the −Y side along the Y-axis according to the polarization switching cycle described above, emits the color light WLS in the same direction as the color light WLP, and emits the image light IL in time series. In a period in which the image light IL1 is emitted from the polarizing separation element 320 to the −Y side along the Y-axis, the image light IL2 is not emitted from the polarizing separation element 320 to the −Y side along the Y-axis. Similarly, in the period in which the image light IL2 is emitted from the polarizing separation element 320 to the −Y side along the Y-axis, the image light IL is not emitted from the polarizing separation element 320 to the −Y side along the Y-axis.

The projection optical system 80 is disposed in the optical path of the image light IL emitted from the polarizing separation element 320, overlaps the polarizing separation element 320 in the X-axis and the Z-axis, and is disposed on the −Y side of the polarizing separation element 320. The projection optical system 80 enlarged and projected the image light IL1 and IL2 generated by the light modulation devices 60 and 260 toward a projection surface such as a screen. The projection optical system 80 is configured of a plurality of optical lenses disposed along the Y-axis. The optical lenses include, for example, a plano-convex lens, a plano-concave lens, a biconvex lens, a biconcave lens, a meniscus lens, an aspherical lens, a free-form surface lens, or the like.

The light source device 230, the polarizing separation element 310, the light scanning device 40, the reflective element 271, the light modulation device 60, the polarizing plate 281, the light scanning device 70, the reflective element 272, the light modulation device 260, the polarizing plate 282, the polarizing separation element 320, and the projection optical system 80 described above constitute an optical section 10 of the projector 211.

The light source output control device 110 is electrically connected to the light emitting element 21 of the light source device 230 in a wired or wireless manner and controls the light amount of the color light WL emitted from the light emitting element 21. Specifically, the light source output control device 110 outputs an electrical signal related to a driving voltage or a driving current for controlling the light amount of the color light WL emitted from the light emitting element 21 to the light emitting element 21 and causes the color light WL to be periodically emitted from the light emitting element 21. The light source output control device 110 is, for example, an LD driver. A driver, which is the light source output control device 110, stores and saves a program of a periodic drive voltage value or drive current value to the light emitting element 21 corresponding to the elapsed time and the time t. The drive voltage value or the drive current value to the light emitting element 21 corresponding to the elapsed time and the time t will be described later.

The rotation control device 120 is electrically connected to the translucent member 42 of the light scanning device 40 and the translucent member 76 of the light scanning device 70 via the motor in a wired or wireless manner and controls the rotation speed of the translucent member 42 around the rotation axis CX1 and the rotation speed of the translucent member 76 around the rotation axis CX2. The rotation control device 120 is configured by, for example, a motor driver.

The drive control device 130 is electrically connected to the light source output control device 110 and the rotation control device 120 and is electrically connected to the spatial light modulator 250 of the light source device 230, the liquid crystal panel 62 of the light modulation device 60, and the liquid crystal panel 262 of the light modulation device 260 in a wired or wireless manner. The drive control device 130 outputs electrical signals to the light source output control device 110 and the rotation control device 120 to control the position, region, and timing on the XZ plane at which the color light WLP irradiated from the spatial light modulator 250 of the light source device 230 is scanned by the translucent member 42 of the light scanning device 40 and applied to the modulation surface 64 of the liquid crystal panel 62 of the light modulation device 60, and the position, region, and timing on the XY plane at which the color light WL irradiated from the spatial light modulator 250 is scanned by the translucent member 76 of the light scanning device 70 and applied to the modulation surface 264 of the liquid crystal panel 262 of the light modulation device 260. The drive control device 130 supplies an electrical signal to each pixel of the liquid crystal panels 62 and 262 on the modulation surfaces 64 and 264 in accordance with the irradiation position, the irradiation region, and the timing of the color light WL described above.

The drive control device 130 drives the pixels corresponding to three primary colors of the light emitting element 21 of the light source device 230, the spatial light modulator 250, the translucent member 42 of the light scanning device 40, the translucent member 76 of the light scanning device 70, the liquid crystal panel 62 of the light modulation device 60, and the liquid crystal panel 262 of the light modulation device 260 in synchronization with each other based on the refresh rate of the liquid crystal panels 62 and 262. When a shift in synchronization occurs between the above described configurations, it may be corrected by feedback using a method of detecting the light amount of the image light IL or the like at every predetermined period. Image processing, frame interpolation, or other processing may be performed as appropriate on the image information output to the liquid crystal panels 62 and 262. The color light WLP and WLS emitted from the spatial light modulator 250 may be subjected to area dimming based on the scanning position by the translucent member 42 and the image information output to the liquid crystal panel 62, or area dimming based on the scanning position by the translucent member 76 and the image information output to the liquid crystal panel 262.

The drive control device 130 is, for example, a processor. The processor as the drive control device 130 stores and saves the timing of supplying the drive voltage value or the drive current value to the light emitting element 21, the timing of supplying the polarization switching cycle of the spatial light modulator 250, the timing of increasing or decreasing the rotation speed of the translucent member 42 and the timing of supplying the drive voltage of the modulation amount of the color light suitable for each pixel of the liquid crystal panel 62, the timing of increasing or decreasing the rotation speed of the translucent member 76 and the timing of supplying the drive voltage of the modulation amount of the color light suitable for each pixel of the liquid crystal panel 262, and the like.

The central processing unit (CPU) 140 is electrically connected to the drive control device 130 in a wired or wireless manner. The central processing unit 140 transmits video information and drive information to the drive control device 130. The central processing unit 140 receives frame information from the video processing circuit 160 and receives information such as a refresh rate of the liquid crystal panel 62 from the user interface (UI) 150. The refresh rate of the liquid crystal panel 62 is arbitrarily set by the user of the projector 201 from options provided in advance, and is, for example, 60 Hz or 90 Hz.

The user interface 150 is electrically connected to the central processing unit 140 in a wired or wireless manner. The user interface 150 transmits information such as the refresh rate to the central processing unit 140. The user interface 150 is, for example, an input device, a tablet terminal device, or the like installed in the projector 201.

The video processing circuit 160 is electrically connected to the central processing unit 140 by wire or wirelessly. The video processing circuit 160 receives the video information from the video interface 170, decomposes the received video information into the frame information for each color, and transmits the frame information for each color of the video or the image to the central processing unit 140. The video processing circuit 160 has, for example, a video random access memory (VRAM), which is a memory dedicated to video processing.

The video interface 170 is electrically connected to the video processing circuit 160 in a wired or wireless manner. The video interface 170 transmits the image information and the video information of the projection target by the projector 201 to the video processing circuit 160.

The light source output control device 110, the rotation control device 120, the drive control device 130, the central processing unit 140, the user interface 150, the video processing circuit 160, and the video interface 170 described above constitute a control section 100 of the projector 201.

Next, scanning of the color light WLP by the light scanning device 40 of the projector 211 will be described. The translucent member 42 of the light scanning device 40 rotates clockwise as indicated by an arrow, for example, around the rotation axis CX1 as viewed from the +X side, that is, the front side of the paper surface of FIG. 1 toward the −X side, that is, the back side of the paper surface of FIG. 1.

In FIG. 1, a first state, that is, an initial state, in the rotation state of the translucent member 42 of the light scanning device 40 is indicated by solid line. In the first state, the side surface 54A of the translucent member 42 is positioned on the most-Z side among the four side surfaces 54 and is parallel to the XY plane. It is assumed that an angle formed counterclockwise between a virtual line TX, which passes through the central axis JX1 and the rotation axis CX1 and which is orthogonal to the side surface 54A, and the axis PX, which extends parallel to the Z-axis and toward the −Z side with the central axis JX1 and the rotation axis CX1 as the origin, is a rotation angle ω. The actual color light WLP has a predetermined light flux width in the X-axis, the Y-axis, and the XY plane. In describing the scanning and the behavior of the color light WLP, attention is focused on the light ray WBM on the optical axis AX of the color light WLP.

As shown in FIG. 1, in the first state, the rotation angle ω is 0°, and the color light WLP incident on the translucent member 42 from the −Z side is incident perpendicularly to the side surface 54A, and thus is not refracted by the side surface 54A. The color light WLP travels in parallel to the Z-axis is incident on the side surface 54C at a right angle, is not refracted by the side surface 54C, and is emitted from the side surface 54C to the +Z side along the Z-axis. The light ray WBM of the color light WLP passes through the center of the side surface 54A on the XY plane, the central axis JX1, the rotation axis CX1, and the center of the side surface 54C on the XY plane. A separation distance d on the Z-axis between the light ray WBM, which was emitted from the side surface 54C of the translucent member 42, and an axis QX, which extends in parallel with the Z-axis and toward the +Z side with the central axis JX1 and the rotation axis CX1 as the origin, is substantially zero.

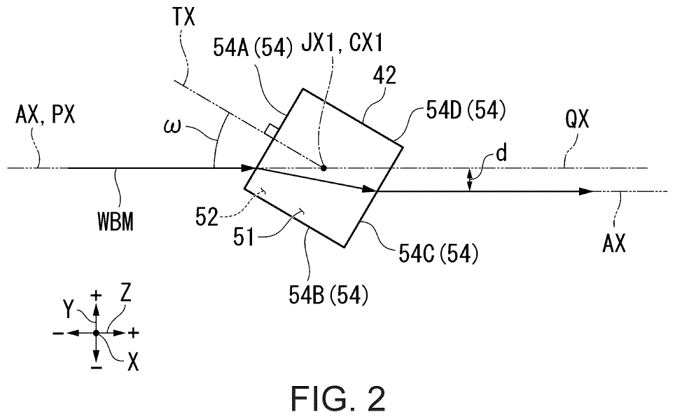

FIG. 2 is a schematic view of a second state in which the rotation of the translucent member 42 has advanced from the first state. As shown in FIG. 2, in the second state, the rotation angle ω is larger than 0° and smaller than 45°. In the second state, the color light WLP incident on the translucent member 42 from the −Z side is incident on the side surface 54A at an incident angle equivalent to the narrow angle formed by the normal of the side surface 54A and the light ray WBM, and thus is refracted at the side surface 54A toward the −Y side with respect to the central axis JX1 in accordance with the incident angle on the side surface 54A, the refractive index n of the material of the translucent member 42, and Snell's law.

In the second state, the color light WLP incident on the inside of the translucent member 42 as described above is refracted by the side surface 54A, is incident on the side surface 54C at an incident angle determined by the incident angle of the color light WLP on the side surface 54A, the refractive index n, and Snell's law, is refracted by the side surface 54C, and is emitted from the side surface 54C to the +Z side along the Z-axis. The separation distance d in the second state is larger than the separation distance d in the first state.

In any state of the rotation of the translucent member 42, the one or two side surfaces 54 among the four side surfaces 54A, 54B, 54C, and 54D of the translucent member 42 on which the color light WLP is incident, and the incident angle at which the color light WLP is incident on one or two side surfaces 54, are determined according to the rotation angle ω. The separation distance d is determined by the incident angle of the color light WLP on one or two side surfaces 54 in accordance with the rotation angle ω, the refractive index n, and the distance on the Z-axis between the side surfaces 54A and 54C and between the side surfaces 54B and 54D, that is, the lengths of the sides of the polygon of the end surfaces 51 and 52.

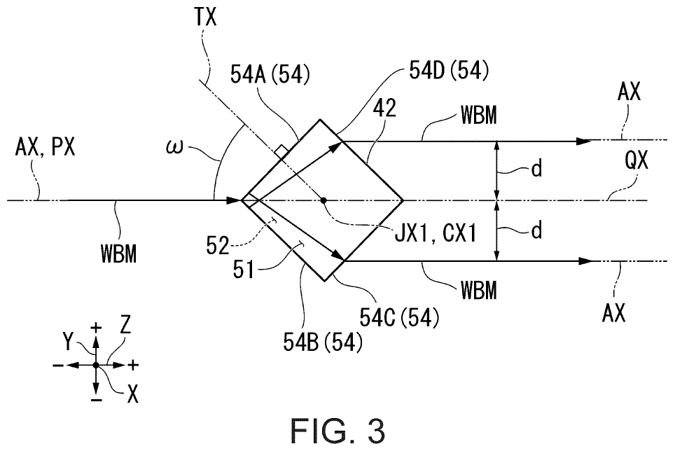

FIG. 3 is a schematic view of a third state in which the rotation of the translucent member 42 is further advanced from the second state. As shown in FIG. 3, the rotation angle ω is 45°, and the light ray WBM of the color light WLP incident on the translucent member 42 from the −Z side is incident on the corner between the side surfaces 54A and 54B. In the third state, of the color light WLP incident on the translucent member 42 from the −Z side, the color light WLP to the +Y side of the corner between the side surfaces 54A and 54B is refracted by the side surface 54A, is incident on the side surface 54C at an incident angle determined by the incident angle of the color light WLP on the side surface 54A, the refractive index n, and Snell's law, is refracted by the side surface 54C, and is emitted from the side surface 54C to the +Z side along the Z-axis, similarly to the second state.

In the third state, of the color light WLP incident on the translucent member 42 from the −Z side, the color light WLP on the −Y side of the corner between the side surfaces 54A and 54B is refracted by the side surface 54B, is incident on the side surface 54D at an incident angle determined by the incident angle of the color light WLP on the side surface 54B, the refractive index n, and Snell's law, is refracted by the side surface 54D, and is emitted from the side surface 54D to the +Z side along the Z-axis. The separation distance d in the third state is larger than the separation distance d in the second state.

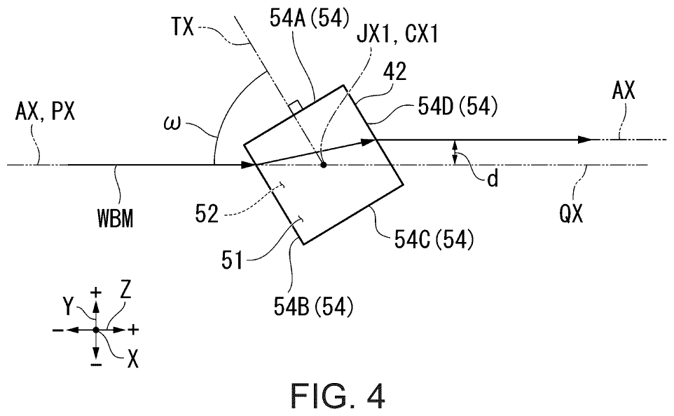

FIG. 4 is a schematic view of a fourth state in which the rotation of the translucent member 42 is further advanced from the third state. As shown in FIG. 4, in the fourth state, the rotation angle @ is larger than 45° and smaller than 90°. In the fourth state, the color light WLP incident on the translucent member 42 from the −Z side is incident at an incident angle equivalent to the narrow angle formed by the perpendicular line of the side surface 54B and the light ray WBM, and thus is refracted to the +Y side from the central axis JX1 by the side surface 54B according to the incident angle to the side surface 54B, the refractive index n, and Snell's law.

In the fourth state, the color light WLP incident on the inside of the translucent member 42 as described above is refracted by the side surface 54B, is incident on the side surface 54D at an incident angle determined by the incident angle of the color light WLP on the side surface 54B, the refractive index n, and Snell's law, is refracted by the side surface 54D, and is emitted from the side surface 54D to the +Z side along the Z-axis. The separation distance d in the fourth state is smaller than the separation distance d in the third state.

Although not shown, when the rotation state of the translucent member 42 advances, the side surface 54A of the translucent member 42 is replaced with the side surface 54B and the side surface 54B is replaced with the side surface 54C in the behaviors from the first state to the fourth state described above. Thereafter, in the behaviors from the first state to the fourth state described above, the side surface 54A of the translucent member 42 is replaced with the side surface 54C, and the side surface 54B is replaced with the side surface 54D. Thereafter, in the behavior from the first state to the fourth state described above, the side surface 54A of the translucent member 42 is replaced with the side surface 54D, and the side surface 54B is replaced with the side surface 54A.

By the circulation of these behaviors, the color light WLP emitted from the translucent member 42 of the light scanning device 40 is scanned along the Y-axis. Since the beam width of the color light WLP incident on the translucent member 42 in the X-axis is larger than the beam width in the Y-axis and equivalent to the size of the modulation surface 64 of the light modulation device 60 in the X-axis, the color light WLP emitted from the translucent member 42 is scanned in the XY plane and is scanned on the modulation surface 64 of the light modulation device 60. In the behaviors from the first state to the fourth state described above, the maximum value of the separation distance d is set to be equal to half the size of the modulation surface 64 on the X-axis or the Z-axis. In view of this, the length and size of one edge of the end surfaces 51 and 52 of the translucent member 42 and the refractive index n are appropriately set so that the maximum value of the separation distance d is equivalent to half the size of the modulation surface 64 on the X-axis or the Z-axis.

The translucent member 76 of the light scanning device 70 of the projector 211 rotates clockwise as indicated by an arrow, for example, around the rotation axis CX2 as viewed from the +X side, that is, as viewed from the front side of the paper surface of FIG. 1, toward the −X side, that is, toward the back side of the paper surface of FIG. 1. The scanning of the color light WLS by the light scanning device 70 is based on the same principle as the scanning of the color light WLP by the light scanning device 40 described above and it is understood by appropriately converting the axes and the planes in the description of the scanning of the color light WLP by the light scanning device 40 described above.

Next, a flow from the emission to the projection of the color light WL in the projector 211 will be described. Returning to FIG. 1, in a first stage, the red light of the S-polarization light is emitted as the color light WL from the light emitting element 21 of the light source device 230. The spatial light modulator 250 is in an OFF state, that is, a state in which the polarization state of the incident color light WL is not converted. The red-color color light WLS is emitted from the spatial light modulator 250, is incident on the polarizing separation element 310, and is reflected. The red-color color light WLS reflected by the polarizing separation element 310 is incident on the light scanning device 70, is scanned, and is incident on the light modulation device 260. The color light WLS incident on the light modulation device 260 is converted into the image light IL2 that is red S-polarization light by an electrical signal corresponding to the image information. The red-color image light IL2 is reflected by the polarizing separation element 320 and is enlarged and projected onto the projection surface such as a screen by the projection optical system 80.

In a second stage, the blue light of the S-polarization light is emitted as the color light WL from the light emitting element 21 of the light source device 230. The spatial light modulator 250 is in an ON state, that is, a state in which the polarization state of the incident color light WL is converted. The blue-color color light WLP is emitted from the spatial light modulator 250, is incident on the polarizing separation element 310, and is transmitted through. The blue-color color light WLP transmitted through the polarizing separation element 310 is incident on the light scanning device 40, is scanned, and is incident on the light modulation device 60. The color light WLP incident on the light modulation device 60 is converted into the blue-color image light IL1 by an electrical signal corresponding to the image information. The image light IL1 that is blue-color P-polarization light is transmitted through the polarizing separation element 320 and is enlarged and projected onto the projection surface such as a screen by the projection optical system 80.

In a third stage, the green light of the S-polarization light is emitted as the color light WL from the light emitting element 21 of the light source device 230. The spatial light modulator 250 is in the OFF state. The green-color color light WLS is emitted from the spatial light modulator 250, is incident on the polarizing separation element 310, and is reflected. The green-color color light WLS reflected by the polarizing separation element 310 is incident on the light scanning device 70, is scanned, and is incident on the light modulation device 260. The color light WLS incident on the light modulation device 260 is converted into image light IL2 that is green S-polarization light by the electrical signal corresponding to the image information. The green-color image light IL2 is reflected by the polarizing separation element 320 and is enlarged and projected onto the projection surface such as a screen by the projection optical system 80.

In a fourth stage, the red light of the S-polarization light is emitted as the color light WL from the light emitting element 21 of the light source device 230. The spatial light modulator 250 is in the ON state. The red-color color light WLP is emitted from the spatial light modulator 250, is incident on the polarizing separation element 310, and is transmitted through. The red-color color light WLP transmitted through the polarizing separation element 310 is incident on the light scanning device 40, is scanned, and is incident on the light modulation device 60. The color light WLP incident on the light modulation device 60 is converted into the red-color image light IL1 by the electrical signal corresponding to the image information. The image light IL1 that is red P-polarization light is transmitted through the polarizing separation element 320 and is enlarged and projected onto the projection surface such as a screen by the projection optical system 80.

In a fifth stage, the blue light of the S-polarization light is emitted as the color light WL from the light emitting element 21 of the light source device 230. The spatial light modulator 250 is in the OFF state. The blue-color color light WLS is emitted from the spatial light modulator 250, is incident on the polarizing separation element 310, and is reflected. The blue-color color light WLS reflected by the polarizing separation element 310 is incident on the light scanning device 70, is scanned, and is incident on the light modulation device 260. The color light WLS incident on the light modulation device 260 is converted into the image light IL2 that is blue S-polarization light by the electrical signal corresponding to the image information. The green-color image light IL2 is reflected by the polarizing separation element 320 and is enlarged and projected onto the projection surface such as a screen by the projection optical system 80.

In a sixth stage, the green light of the S-polarization light is emitted as the color light WL from the light emitting element 21 of the light source device 230. The spatial light modulator 250 is in the ON state. The green-color color light WLP is emitted from the spatial light modulator 250, is incident on the polarizing separation element 310, and is transmitted through. The green-color color light WLP transmitted through the polarizing separation element 310 is incident on the light scanning device 40, is scanned, and is incident on the light modulation device 60. The color light WLP incident on the light modulation device 60 is converted into the green-color image light IL1 by the electrical signal corresponding to the image information. The image light IL1 that is green P-polarization light is transmitted through the polarizing separation element 320 and is enlarged and projected onto the projection surface such as a screen by the projection optical system 80.

In the optical section 10 of the projector 211, the flow from the first stage to the sixth stage described above is repeated.

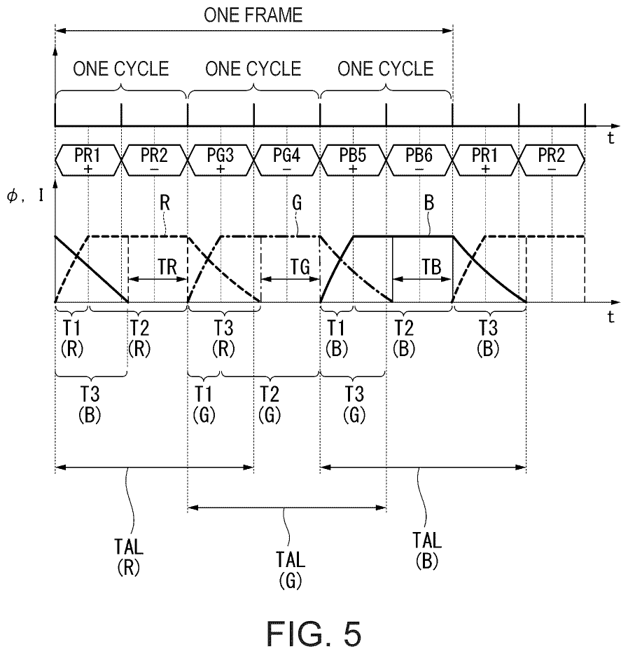

Next, control of the control section 100 with respect to the optical section 10 of the projector 201 will be described. FIG. 5 is a time chart related to the operations of the light emitting element 21 and the spatial light modulator 250 of the light source device 230, and the liquid crystal panel 62 of the light modulation device 60.

In the following description, an input image to the liquid crystal panel 62 of the light modulation device 60 is divided into eight parts on the X-axis, which is orthogonal to the scanning direction of the color light WL. As viewed from the +Y side along the Y-axis, the input image to the liquid crystal panel 62 is divided into a first region X1, a second region X2, a third region X3, a fourth region X4, a fifth region X5, a sixth region X6, a seventh region X7, and an eighth region X8 from the −X side toward the +X side along the X-axis.

In the input image to the liquid crystal panel 62, for example, the first region X1 is assigned the white color and is displayed by combining the red light, the green light, and the blue light. The second region X2 is assigned the red color and is displayed by monochrome light of only the red light. The third region X3 is assigned yellow color light and is displayed by combining the red light and the green light. The fourth region X4 is assigned the green color and is displayed by monochrome light of only the green light. The fifth region X5 is assigned cyan color and is displayed by combining the green light and the blue light. The sixth region X6 is assigned blue color and is displayed by monochrome light of only the blue light. The seventh region X7 is assigned magenta color and displayed by combining the red light and the blue light. The eighth region X8 is assigned black color and does not include any of the red light, the green light, and the blue light.

As shown in FIG. 5, in each pixel of the liquid crystal panel 62, a leading-edge period T1 from the leading-edge start time to the leading-edge completion time, a constant period T2 from the leading-edge completion time to the trailing-edge start time, and a trailing-edge period T3 from the trailing-edge start time to the trailing-edge completion time are generated in each of a red-color region R, a green-color region G, and a blue-color region B.

The leading-edge period T1 corresponds to a first period (to be described later). The constant period T2 corresponds to a second period (to be described later). In the liquid crystal panel 62, the leading-edge period T1 is, for example, about 1.5 ms, and the trailing-edge period T3 is, for example, about 3.0 ms.

In the time chart shown in FIG. 5, for example, it is assumed that the red color, the green color, and the blue color displayed in each frame are switched by driving at 360 Hz. In this case, the frame rate is 180 fps, and the color display is 60 fps. One cycle is about 2.78 ms.

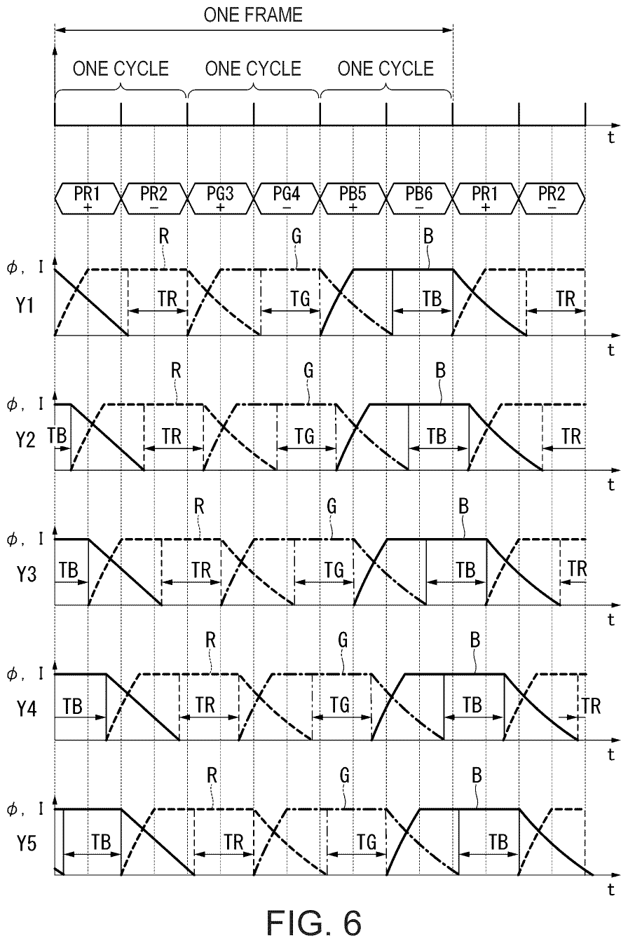

FIG. 6 is a time chart in which, like FIG. 5, the horizontal axis represents time t, and the vertical axis represents a response rate of the liquid crystal and the light intensity of color light in each of the regions, from a first region Y1 to a second region Y2, a third region Y3, a fourth region Y4, and a fifth region Y5, when the modulation surface 64 of the liquid crystal panel 62 of the projector 211 of the first embodiment is divided along the scanning direction, that is, the Z-axis, from the +Z side to the −Z side.

As shown in FIG. 5 and FIG. 6, the red light of the color light WLP irradiated from the light source device 230 is irradiated on the modulation surface 64 through the color filter during a red-color irradiation period TR, which, in the constant period T2 of the red-color region R, does not overlap with the trailing-edge period T3 of the blue-color region B nor with the leading-edge period T1 of the green-color region G. The trailing-edge start time of the red-color region R and the leading-edge start time of the green-color region G coincide with each other.

The green light of the color light WLP irradiated from the light source device 230 is irradiated on the modulation surface 64 through the color filter during a green-color irradiation period TG, which, in the constant period T2 of the green-color region G, does not overlap with the trailing-edge period T3 of the red-color region R nor with the leading-edge period T1 of the blue-color region B. The blue light of the color light WLP irradiated from the light source device 230 is irradiated on the modulation surface 64 through the color filter during a blue-color irradiation period TB, which, in the constant period T2 of the blue-color region B, does not overlap with the trailing-edge period T3 of the green-color region G nor with the leading-edge period T1 of the red-color region R.

The time chart regarding the operations of the light emitting element 21 and the spatial light modulator 250 of the light source device 230 and the liquid crystal panel 262 of the light modulation device 260 is the same as the time chart regarding the operations of the light source device 230 and the liquid crystal panel 62 of the light modulation device 60 described above with reference to FIG. 5 and FIG. 6.

That is, in the projector 211, each color light is irradiated only in a period in which the response of the liquid crystal of each pixel of the liquid crystal panels 62 and 262 is completed. Therefore, the color of the input image input from the control section 100 is accurately reproduced in the entire area of the image projected onto the projection surface such as a screen (not shown). In each of the red-color region R, the green-color region G, and the blue-color region B, the color light from the light emitting element 21 is irradiated during the entire period that does not overlap with the leading-edge period or the trailing-edge period of the other color regions after the response of the liquid crystal is completed.

A positive drive voltage PR1 and a negative drive voltage PR2 corresponding to the red light, a positive drive voltage PG3 and a negative drive voltage PG4 corresponding to the green light, and a positive drive voltage PB5 and a negative drive voltage PB6 corresponding to the blue light are sequentially supplied to each pixel of the liquid crystal panel 62 of the light modulation device 60 according to the frame rate.

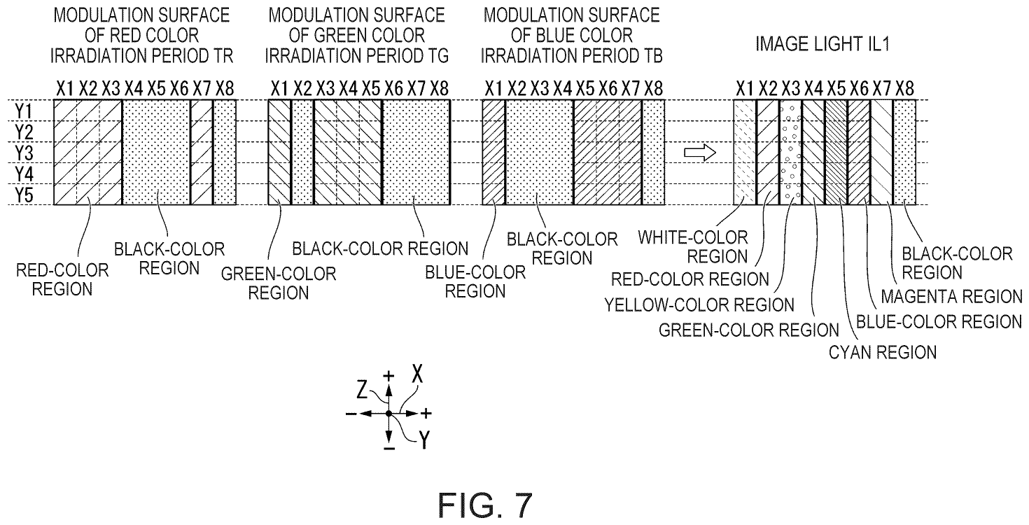

FIG. 7 is a schematic view showing the distribution of the color regions on the modulation surface 64. As shown in FIG. 7, in the projector 211 of a scanning type illumination controlled as shown in FIG. 5 and FIG. 6, the brightness of the image light IL1 is improved as compared with a projector of a in-plane collective illumination in the related art. By the above described control, in any region of the modulation surface 64 and at any time t, illuminance unevenness and the loss of the projection image on the projection surface are suppressed, and color mixture does not occur.

The positive drive voltage PR1 and the negative drive voltage PR2 corresponding to the red light, the positive drive voltage PG3 and the negative drive voltage PG4 corresponding to the green light, and the positive drive voltage PB5 and the negative drive voltage PB6 corresponding to the blue light are sequentially supplied to each pixel of the liquid crystal panel 262 of the light modulation device 260 according to the frame rate. In the projector 211, the brightness of the image light IL2 is also improved as compared with the projector of the in-plane collective illumination in the related art. By the above described control, in any region of the modulation surface 264 and at any time t, illuminance unevenness and the loss of the projection image on the projection surface are suppressed, and color mixture does not occur.

In the projector 211 with the scanning type illumination, the relative beam width of the color light WLP on the Z-axis on the modulation surface 64 of the light modulation device 60 is large, and each of the red-color irradiation period TR, the green-color irradiation period TG, and the blue-color irradiation period TB is secured to be relatively long as shown in FIG. 5 to FIG. 7. In the case of obtaining a constant brightness of the image light IL1, the optical density is suppressed, and the reliability of the projector 211 is high. The relative beam width of the color light WLP in the Z-axis is large, and thus the irradiation efficiency of the color light WLP is high. Note that in the case where each of the red-color irradiation period TR, the green-color irradiation period TG, and the blue-color irradiation period TB is ensured to be relatively long as shown in FIG. 5 to FIG. 7, a measure is required for, as the end approaches due to of the scanning of the color light WLP, preventing a different color light from appearing at the start end.

In the projector 211 of the scanning type illumination, when the relative beam width of the color light WL in the Z-axis on the modulation surface 64 of the light modulation device 60 is shortened, each of the red-color irradiation period TR, the green-color irradiation period TG, and the blue-color irradiation period TB is relatively shortened. In the case of obtaining a constant brightness of the image light IL1, the optical density is increased, and the reliability of the projector 211 is low. The relative beam width of the color light WLP in the Z-axis is small, and thus the irradiation efficiency of the color light WLP is low. When a drive frequency of the liquid crystal of the liquid crystal panel 62 is increased, the above described tendency is approached.

In the scanning type illumination projector 211, the increase and decrease in the relative beam width of the color light WL in the Y-axis on the modulation surface 264 of the light modulation device 260 and the influence of the increase and decrease are the same as the above-described increase and decrease in the relative beam width of the color light WL in the Z-axis on the modulation surface 64 of the light modulation device 60 and the influence of the increase and decrease.

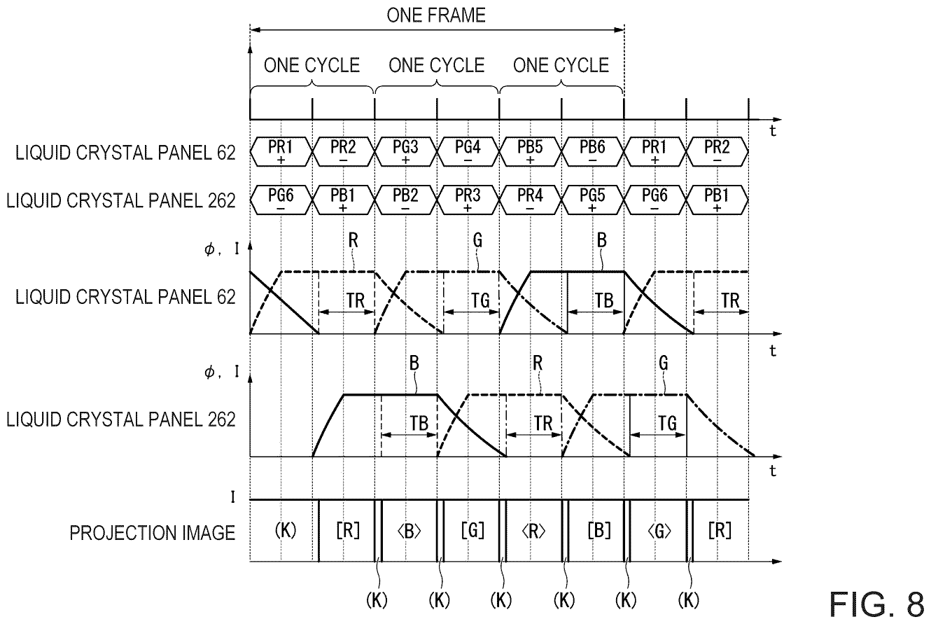

FIG. 8 is a time chart of a modulation amount φ related to the response rate of the liquid crystal in each of the liquid crystal panel 62 of the light modulation device 60 and the liquid crystal panel 262 of the light modulation device 260, the color light WLP and WLS with which the liquid crystal panels 62 and 262 are irradiated, and of the change in the display color in the projection image, for each region of the modulation surface 64.

As shown in FIG. 8, in the projector 211, when the color light WLP is irradiated in synchronization with the red-color irradiation period TR of the red-color region R of the liquid crystal panel 62 of the light modulation device 60, the red-color image light projected. The red-color irradiation period TR of the red-color region R of the liquid crystal panel 62 overlaps with the leading-edge period T1 of the blue-color region B of the liquid crystal panel 262 of the light modulation device 260 and a part of the first half of the constant period T2. However, the color light WLS is not irradiated in the leading-edge period T1 and the first half of the constant period T2 of the blue-color region B of the liquid crystal panel 262. Therefore, in the red-color irradiation period TR of the red-color region R of the liquid crystal panel 62, the red-color image light IL1 is displayed in the projection image.

When the color light WLP is irradiated in synchronization with the green-color irradiation period TG of the green-color region G of the liquid crystal panel 62 of the light modulation device 60, the green-color image light IL1 is generated and projected. The green-color irradiation period TG of the green-color region G of the liquid crystal panel 62 overlaps most of the trailing-edge period T3 of the blue-color region B of the liquid crystal panel 262 of the light modulation device 260 and the leading-edge period T1 and a part of the first half of the constant period T2 of the red-color region R. However, the color light WLS is not irradiated to most of the trailing-edge period T3 of the blue-color region B of the liquid crystal panel 262 and the leading-edge period T1 and a part of the first half of the constant period T2 of the red-color region R. Therefore, in the green-color irradiation period TG of the green-color region G of the liquid crystal panel 62, the green-color image light IL1 is displayed in the projection image.

When the color light WLP is irradiated in synchronization with the blue-color irradiation period TB of the blue-color region B of the liquid crystal panel 62 of the light modulation device 60, the blue-color image light IL1 is generated and projected. The blue-color irradiation period TB of the blue-color region B of the liquid crystal panel 62 overlaps most of the trailing-edge period T3 of the red-color region R of the liquid crystal panel 262 of the light modulation device 260 and the leading-edge period T1 and a part of the first half of the constant period T2 of the green-color region G. However, the color light WLS is not irradiated to most of the trailing-edge period T3 of the red-color region R of the liquid crystal panel 262, and the leading-edge period T1 and a part of the first half of the constant period T2 of the green-color region G. Therefore, in the blue-color irradiation period TB of the blue-color region B of the liquid crystal panel 62, the blue-color image light IL1 is displayed in the projection image.

When the color light WLS is irradiated in synchronization with the red-color irradiation period TR of the red-color region R of the liquid crystal panel 262 of the light modulation device 260, the red-color image light IL2 is generated and projected. The red-color irradiation period TR of the red-color region R of the liquid crystal panel 262 overlaps most of the trailing-edge period T3 of the green-color region G of the liquid crystal panel 62 of the light modulation device 60 and the leading-edge period T1 and a part of the first half of the constant period T2 of the blue-color region B. However, the color light WLP is not irradiated to most of the trailing-edge period T3 of the green-color region G of the liquid crystal panel 62 and the leading-edge period T1 and a part of the first half of the constant period T2 of the blue-color region B. Therefore, in the red-color irradiation period TR of the red-color region R of the liquid crystal panel 262, the red-color image light IL2 is displayed in the projection image.

The red-color irradiation period TR of the red-color region R of the liquid crystal panel 262 and a red display period <R> of the projection image by the image light IL2 are generated with a black display period (K) interposed between a green display period [G] and a blue display period [B] of the projection image by the image light IL1.

When the color light WLS is irradiated in synchronization with the green-color irradiation period TG of the green-color region G of the liquid crystal panel 262 of the light modulation device 260, the green-color image light IL2 is generated and projected. The green-color irradiation period TG of the green-color region G of the liquid crystal panel 262 overlaps most of the trailing-edge period T3 of the blue-color region B of the liquid crystal panel 62 of the light modulation device 60 and the leading-edge period T1 and a part of the first half of the constant period T2 of the red-color region R. However, the color light WLP is not irradiated to most of the trailing-edge period T3 of the blue-color region B of the liquid crystal panel 62 and the leading-edge period T1 and a part of the first half of the constant period T2 of the red-color region R and. Therefore, in the green-color irradiation period TG of the green-color region G of the liquid crystal panel 262, the green-color image light IL2 is displayed in the projection image.

The green-color irradiation period TG of the green-color region G of the liquid crystal panel 262 and the green display period <G> of the projection image by the image light IL2 are generated with the black display period (K) interposed between the blue display period [B] and the red display period [R] of the projection image by the image light IL1.

When the color light WLS is irradiated in synchronization with the blue-color irradiation period TB of the blue-color region B of the liquid crystal panel 262 of the light modulation device 260, the blue-color image light IL2 is generated and projected. The blue-color irradiation period TB of the blue-color region B of the liquid crystal panel 262 overlaps most of the trailing-edge period T3 of the red-color region R of the liquid crystal panel 62 of the light modulation device 60 and the leading-edge period T1 and a part of the first half of the constant period T2 of the green-color region G. However, the color light WLP is not irradiated to most of the trailing-edge period T3 of the red-color region R of the liquid crystal panel 62 and the leading-edge period T1 and a part of the first half of the constant period T2 of the green-color region G. Therefore, in the blue-color irradiation period TB of the blue-color region B of the liquid crystal panel 262, the blue-color image light IL2 is displayed in the projection image.

The blue-color irradiation period TB of the blue-color region B of the liquid crystal panel 262 and the blue display period <B> of the projection image by the image light IL2 are generated with the black display period (K) interposed between the red display period [R] and the green display period [G] of the projection image by the image light IL1.

That is, in the projector 211, the timing and the period at which the color light WLP is incident on the liquid crystal panel 62 and the timing and the period at which the color light WLS is incident on the liquid crystal panel 262 are different from each other. The wavelength of the color light WLP incident on the liquid crystal panel 62 and the wavelength of the color light WLS incident on the liquid crystal panel 262 are different from each other. Therefore, in the projector 211, not only the black display period (K) but also the blue display period [B] by the liquid crystal panel 262 occurs between the red display period <R> and the green display period <G> of the projection image in the case where only the liquid crystal panel 62 is used as in the single-plate type projector. Not only the black display period (K) but also the red display period [R] by the liquid crystal panel 262 is generated between the green display period <G> and the blue display period <B> by the liquid crystal panel 62. Not only the black display period (K) but also the green display period [G] by the liquid crystal panel 262 is generated between the blue display period <B> and the red display period <R> by the liquid crystal panel 62.

The projector 211 adopts the two-plate type configuration, and any one display period of the red display periods <R> and [R], the green display periods <G> and [G], and the blue display periods <B> and [B] occurs in the black display period (K) of each of the two light modulation devices 60 and 260, and the cycle of color display in the projection image is shorter than that in the case where only one light modulation device of the light modulation devices 60 and 260 is used as in the single-plate type configuration. Thus, when an observer observes the projection image with high-speed eye movements, the occurrence of color break-up is suppressed, and the separation of the image light IL1 and IL2 of the plurality of colors at the time t is hardly visually recognized or perceived.

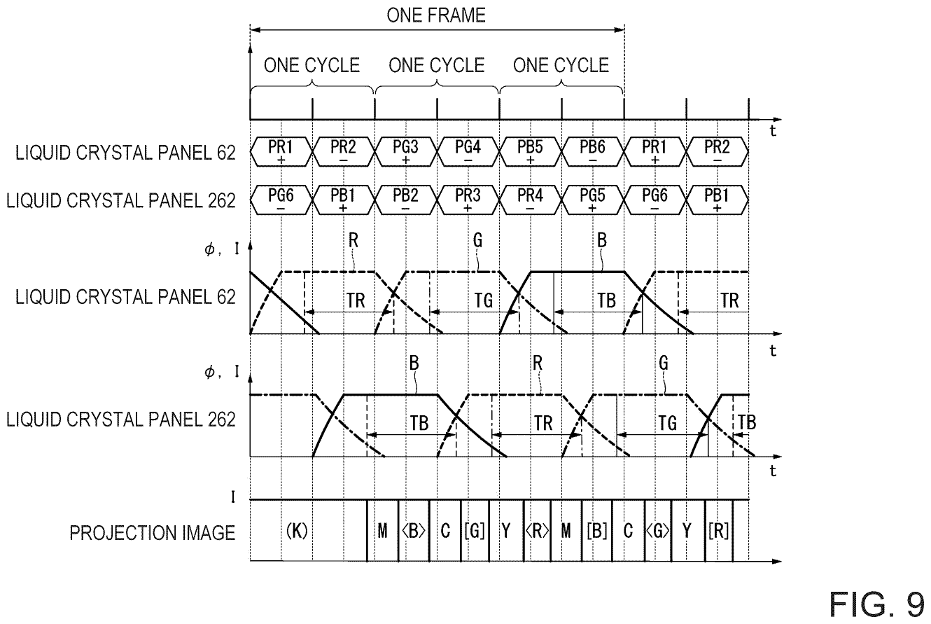

FIG. 9 is a time chart of the modulation amount φ related to the response rate of the liquid crystal in each of the liquid crystal panel 62 of the light modulation device 60 and the liquid crystal panel 262 of the light modulation device 260, the color light WLP and WLS with which the liquid crystal panels 62 and 262 are irradiated, and the change in the display color in the projection image, for each region of the modulation surface 64, and is different from FIG. 8.

As shown in FIG. 9, the red-color irradiation period TR of the liquid crystal panels 62 and 262 may be extended to, for example, a period from a predetermined time after the leading edge of the red-color region R to the intersection time of the trailing edge of the red-color region R and the leading edge of the green-color region G. Similarly, the green-color irradiation period TG may be extended to a period from a predetermined time after the leading edge of the green-color region G to the intersection time of the trailing edge of the green-color region G and the leading edge of the blue-color region B. The blue-color irradiation period TB may be extended to a period from a predetermined time after the leading edge of the blue-color region B to the intersection time of the trailing edge of the blue-color region B and the leading edge of the red-color region R.

In the case of the control as shown in FIG. 9, a period in which the red-color irradiation period TR of the liquid crystal panel 62 and the blue-color irradiation period TB of the liquid crystal panel 262 overlap each other in time t occurs, the red-color image light IL1 and the blue-color image light IL2 are projected, and magenta is displayed in the projection image. A period in which the green-color irradiation period TG of the liquid crystal panel 62 and the blue-color irradiation period TB of the liquid crystal panel 262 overlap each other in time t occurs, the green-color image light IL1 and the blue-color image light IL2 are projected and cyan is displayed in the projection image.

A period in which the green-color irradiation period TG of the liquid crystal panel 62 and the red-color irradiation period TR of the liquid crystal panel 262 overlap each other in time t occurs, the green-color image light IL1 and the red-color image light IL2 are projected and yellow is displayed in the projection image. A period in which the blue-color irradiation period TB of the liquid crystal panel 62 and the red-color irradiation period TR of the liquid crystal panel 262 overlap each other in time t is occurs, the blue-color image light IL1 and the red-color image light IL2 are projected and magenta is displayed in the projection image.

A period in which the blue-color irradiation period TB of the liquid crystal panel 62 and the green-color irradiation period TG of the liquid crystal panel 262 overlap each other in time t is occurs, the blue-color image light IL1 and the green-color image light IL2 are projected and cyan is displayed in the projection image. A period in which the red-color irradiation period TR of the liquid crystal panel 62 and the green-color irradiation period TG of the liquid crystal panel 262 overlap each other in time t is occurs, the red-color image light IL1 and the green-color image light IL2 are projected and yellow is displayed in the projection image.

In the case of the control as shown in FIG. 9, in the projection image, magenta display, yellow display, and cyan display are performed in addition to red display, green display, and blue display, and the projection image is displayed in full color of six colors in a time-division manner. The period of each color display is shortened as compared with the case of the control as shown in FIG. 8. This further suppresses the occurrence of color breakup and improves the brightness of the projection image. However, in the case of the control as shown in FIG. 9, the triangular region of the chromaticity diagram, which can be represented by the projection image, is narrowed because each vertex is closer to the center than in the case of the control as shown in FIG. 8. In consideration of these, the red-color irradiation period TR, the green-color irradiation period TG, and the blue-color irradiation period TB in each of the liquid crystal panels 62 and 262 are appropriately set in accordance with the quality that is considered important amongst quality of the projection image such as the degree of suppression of the occurrence of color breakup, the brightness of the projection image, or the size of the color gamut in the projection image.

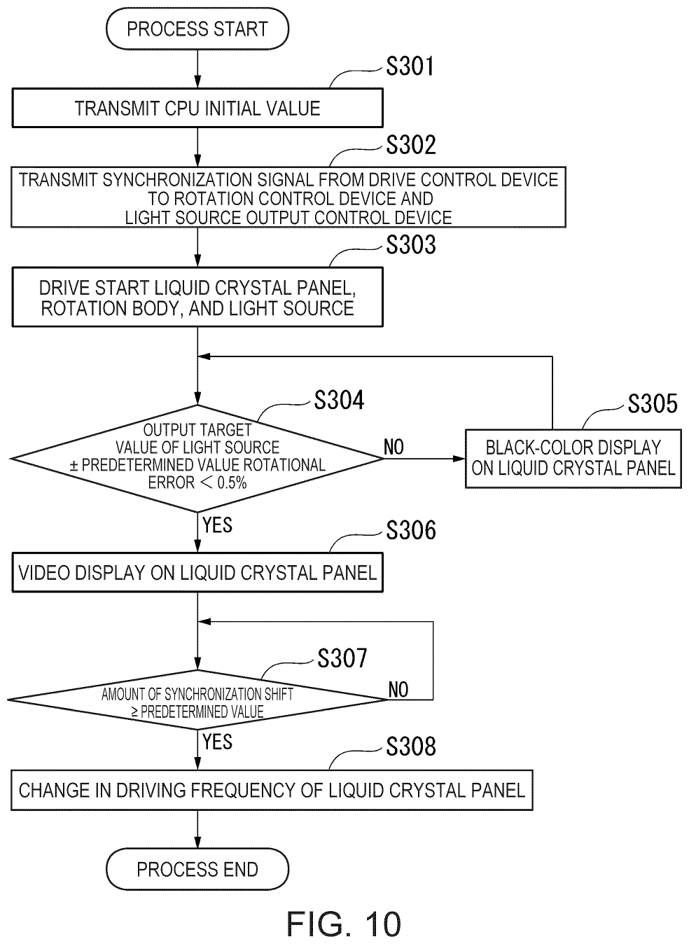

FIG. 10 is a flowchart relating to the control performed by the control section 100 as shown in FIG. 5 to FIG. 9. As shown in FIG. 10, in step S301, the central processing unit 140 transmits various initial values to the drive control device 130 based on the video information received from the video processing circuit 160 and the refresh rate of the liquid crystal of the liquid crystal panels 62 and 262 set by the user interface 150 or the like. The various initial values include video information of a projection target, a drive frequency of the light emitting element 21, a polarization switching cycle of the spatial light modulator 250, the drive frequency of the liquid crystal panel 62, an operation time, a standby period, a threshold value for determining various erroneous operation differences, and the like.

In step S302, a synchronization signal is transmitted from the drive control device 130 to the light source output control device 110 and the rotation control device 120. In step S303, an electrical signal is received from the light source output control device 110 and the rotation control device 120, the color light WL is periodically emitted from the light emitting element 21 of the light source device 20, the color light WLP and WLS is periodically emitted from the spatial light modulator 250, the translucent member 42 of the light scanning device 40 rotates around the rotation axis CX1, the translucent member 76 of the light scanning device 70 rotates around the rotation axis CX2, the color light WLP is converted into the image light IL1 by the liquid crystal of each pixel of the liquid crystal panel 62 of the light modulation device 60, and the color light WLS is converted into the image light IL2 by the liquid crystal of each pixel of the liquid crystal panel 262 of the light modulation device 260. At this time, errors representing shifts from the set values of the light amount and output of the color light WL of the light emitting element 21 and the rotation speed of the translucent members 42 and 76 are constantly detected and fed back to the drive control device 130.

In the case where the error between the output of the light emitting element 21 and a predetermined target value exceeds a predetermined value in step S304, and in the case where the error in the rotation speed of the translucent members 42 and 76 exceeds a target error range of, for example, about 0.5%, each pixel of the liquid crystal panel 62 displays black in step S305 until the error falls within the target error range. When the error in the output of the light emitting element 21 and the rotation speed of the translucent members 42 and 76 falls within the target error range, the color light WLP and WLS is converted into the image light IL1 and IL2 in the pixels of the liquid crystal panels 62 and 262 in step S306.

In step S307, when the image light IL1 and IL2 is generated in each pixel of the liquid crystal panels 62 and 262, and the amount of synchronization shift between the cycle of output of the light emitting element 21 and the rotation speed of the translucent members 42 and 76 are detected at a constant cycle, that is, at a constant time interval. While the amount of the synchronization shift between the output cycle of the light emitting element 21 and the rotation speed of the translucent members 42 and 76 is detected to be less than the predetermined value, each setting condition and setting value are maintained. The polarization switching cycle of the spatial light modulator 250 is synchronized with the output cycle of the light emitting element 21.

When it is detected that the amount of the synchronization shift between the cycle of the output of the light emitting element 21 and the rotation speed of the translucent members 42 and 76 are equal to or greater than the predetermined value, the drive frequency of the liquid crystal panels 62 and 262 are changed to reduce the amount of the synchronization shift in step S308. The timing of synchronization between the output cycle of the light emitting element 21 and the rotation speed of the translucent members 42 and 76 are adjusted mainly by the liquid crystal panels 62 and 262. The rotation angle of the translucent members 42 and 76 of the light scanning devices 40 and 70 and the timing of emission of the color light WL from the light emitting element 21 of the light source device 230 are matched to the liquid crystal panels 62 and 262.

As an example, when the drive frequency of the liquid crystal panel 62 in the Z-axis and the drive frequency of the liquid crystal panel 262 in the Y-axis are 1080/1124 lines, there is a margin of adjustment of about 97%. Note that after the drive frequency of the liquid crystal panels 62 and 262 is changed in step S308, the process returns to step S306, and the modulation and the video display are performed on the liquid crystal panels 62 and 262 based on the input image under the changed conditions.

The projector 211 according to the first embodiment described above includes the light source device 230, the light modulation devices 60 and 260, and the projection optical system 80. The light source device 230 periodically emits the color light (illumination light) WL including the color light (first light) WLP as the P-polarization light and the color light (second light) WLS as the S-polarization light. The light modulation device 60 modulates the color light WL emitted from the light source device 230 in accordance with the image information to generate the image light IL1. The light modulation device 260 modulates the color light WL emitted from the light source device 230 in accordance with the image information to generate the image light IL2. The projection optical system 80 projects the image light IL1 and IL2 emitted from the light modulation devices 60 and 260 onto the projection surface such as a screen. The light source device 230 has the light emitting element 21 that emits the color light WLP and WLS. The light modulation devices 60 and 260 have the liquid crystal panel (first liquid crystal element) 62 and the liquid crystal panel (second liquid crystal element) 262. The liquid crystal panel 62 converts the incident color light WLP into the image light (first image light) IL1 in accordance with the image information that was input, thereby forming the image. The liquid crystal panel 262 converts the incident color light WLS into the image light (second image light) IL2 in accordance with the image information that was input, thereby forming the image. In the projector 211 according to the first embodiment, the irradiation cycle of the color light WLP irradiated from the light source device 230 and irradiated on the liquid crystal panel 62 and the image forming cycle of the liquid crystal panel 62 are synchronized with each other. The irradiation cycle of the color light WLS irradiated from the light source device 230 and irradiated on the liquid crystal panel 262 and the image forming cycle of the liquid crystal panel 262 are synchronized with each other. The image forming cycle of the liquid crystal panel 62 and the image forming cycle of the liquid crystal panel 262 are shifted from each other. That is, the timing and the time period when the image is formed by the liquid crystal panel 62 and the timing and the time period when the image is formed by the liquid crystal panel 262 are shifted from each other. In the projector 211 according to the first embodiment, the color and the wavelength of the color light WLP incident on the liquid crystal panel 62 are different from the color and the wavelength of the color light WLS incident on the liquid crystal panel 262.

In the projector 211 according to the first embodiment, the two-plate type configuration is adopted, the image forming cycle in the liquid crystal panel 62 of the light modulation device 60 and the image forming cycle in the liquid crystal panel 262 are synchronized with each other, and the color and the wavelength of the color light WLP incident on the liquid crystal panel 62 and the color and the wavelength of the color light WLS incident on the liquid crystal panel 262 are different from each other. For these reasons, in the projector 201 according to the first embodiment, the cycle and the period of the color display of the projection image are shorter than those in the case where the image is formed only by each of the liquid crystal panels 62 and 262. According to the projector 201 of the first embodiment, it is possible to suppress the occurrence of color breakup in the projection image.

The projector 211 according to the first embodiment further includes the light scanning devices 40 and 70 that periodically scan the color light WLP and WLS emitted from the light source device 230 and emit the color light WLP and WLS to the light modulation devices 60 and 260.

Since the projector 211 according to the first embodiment includes the light scanning devices 40 and 70, for example, as referred to FIG. 5 and FIG. 6, the color light WLP and WLS can be irradiated for a constant period T2 after the completion of the leading edge of the modulation amount of the liquid crystal layers 68 and 268 of each pixel in the liquid crystal panels 62 and 262 of the light modulation devices 60 and 260. According to the projector 211 of the first embodiment, the color of the image information input to the liquid crystal panels 62 and 262 is satisfactorily reproduced in the entire region of the image projected on the projection surface, and the brightness of the projection image can be improved.

In the projector 211 according to the first embodiment, the light scanning device 40 has the translucent member (transmissive optical element) 42. The translucent member 42 scans the incident color light (illumination light) WLP along the first direction parallel to the Y-axis, and has side surfaces (incident surfaces) 54A, 54B, 54C, and 54D on which the color light WLP emitted from the light source device 230 is incident, and side surfaces (emitting surfaces) 54C, 54D, 54A, and 54B from which the color light WLP incident from the side surfaces 54A, 54B, 54C, and 54D is emitted. The light scanning device 70 has the translucent member (transmissive optical element) 76. The translucent member 76 scans the incident color light (illumination light) WLS along the first direction parallel to the Z-axis, and has side surfaces (incident surfaces) 74A, 74B, 74C, and 74D on which the color light WLS emitted from the light source device 230 is incident, and side surfaces (emitting surfaces) 74C, 74D, 74A, and 74B from which the color light WLS incident from the side surfaces 74A, 74B, 74C, and 74D is emitted The translucent member 42 has the end surfaces (first surface) 51 and 52 parallel to the Y-axis and the first direction, and 2×m side surfaces (second surfaces) 54 in contact with the end surfaces 51 and 52. The translucent member 76 has the end surfaces (first surface) 71 and 72 parallel to the Z-axis and the first direction, and 2×m side surfaces (second surfaces) 74 in contact with the end surfaces 71 and 72.

In the projector 211 of the first embodiment, the translucent member 42 has four or more even number of side surfaces 54, and all of the side surfaces 54 are opposed to side surfaces 54 with the central axis JX1 interposed therebetween and are parallel to each other. The translucent member 76 has four or more even number of side surfaces 74, and all of the side surfaces 74 are opposed to side surfaces 74 with the central axis JX2 interposed therebetween and are parallel to each other. According to the projector 201 of the first embodiment, the color light WLP emitted from the light source device 230 and incident on the light scanning device 40 can be emitted in a direction parallel to the direction of the color light WLP incident from the light scanning device 40. The color light WLS emitted from the light source device 230 and incident on the light scanning device 70 can be emitted in a direction parallel to the direction of the color light WLS incident from the light scanning device 70.

In the projector 211 according to the first embodiment, the liquid crystal panel 62 of the light modulation device 60 has the liquid crystal layer (first liquid crystal layer) 68 in which the modulation amount with respect to the color light WLP changes in accordance with an electrical signal having the image information that was input. The liquid crystal panel 262 of the light modulation device 260 has the liquid crystal layer (second liquid crystal layer) 268 in which the modulation amount with respect to the color light WLS changes in accordance with an electrical signal having the image information that was input. A modulation period TAL of the liquid crystal layers 68 and 268 includes the leading-edge period (first period) T1 and the constant period (second period) T2. The leading-edge period T1 is a period from the time when the electrical signals are input to the liquid crystal layers 68 and 268 to the time when the modulation amount of the phases with respect to the color light WLP and WLS reaches a predetermined value. The constant period T2 is a period during which the modulation amounts of the phases of the color light WLP and WLS are maintained at predetermined values. The color light WLP and WLS emitted from the light source device 230 is incident on the liquid crystal panels 62 and 262 for the constant period T2.

According to the projector 211 of the first embodiment, the color light WLP and WLS is irradiated on the liquid crystal layers 68 and 268 of the liquid crystal panels 62 and 262 for the constant period T2, and thus it is possible to suppress illuminance unevenness and color mixture of the projection image.

In the projector 211 according to the first embodiment, the time period of the leading-edge period T1 of the liquid crystal layer 68 of the liquid crystal panel 62 is included in the constant period T2 of the liquid crystal layer 268 of the liquid crystal panel 262. The color light WLS is incident on the liquid crystal panel 262 in a time period in which the leading-edge period T1 of the liquid crystal layer 68 and the constant period T2 of the liquid crystal layer 268 overlap.

In the projector 211 according to the first embodiment, for example, the leading-edge period T1 of the green-color region G of the liquid crystal layer 68 of the liquid crystal panel 62 overlaps the constant period T2 of the blue-color region B of the liquid crystal layer 268 of the liquid crystal panel 262 at the time t, and is included in the constant period T2 of the blue-color region B of the liquid crystal layer 268. According to the projector 211 of the first embodiment, it is possible to suppress illuminance unevenness of the projection image, to shorten the cycle of the color display in the projection image, and to suppress the occurrence of color breakup.

The projector 211 according to the first embodiment further includes the drive control device 130 that transmits the electrical signal for driving the liquid crystal of the liquid crystal layers 68 and 268 of each pixel to the liquid crystal panels 62 and 262 of the light modulation devices 60 and 260. The drive control device 130 transmits the electrical signal (synchronization signal) to the light source device 230 to synchronize the output power of the color light WL from the light emitting element 21 and the light modulation devices 60 and 260 based on an electrical signal related to the image information output to the liquid crystal panels 62 and 262.

The projector 211 according to the first embodiment can easily synchronize the output power of the color light WL emitted from the light emitting element 21 and the driving of the light modulation devices 60 and 260 by including the drive control device 130.

The projector 211 according to the first embodiment further includes the drive control device 130 that performs scanning illumination and transmits the electrical signal for driving the liquid crystal of the liquid crystal layers 68 and 268 of each pixel to the liquid crystal panels 62 and 262 of the light modulation devices 60 and 260. The drive control device 130 transmits the electrical signal (synchronization signal) to the light source device 230 and the light scanning devices 40 and 70 to synchronize the output power of the color light WL from the light emitting element 21 and the light modulation devices 60 and 260 based on the electrical signal related to the image information output to the liquid crystal panels 62 and 262.

The projector 211 according to the first embodiment can easily synchronize the output power of the color light WL emitted from the light emitting element 21 and the rotation speed of the translucent members 42 and 76 of the light scanning devices 40 and 70 by including the drive control device 130.

In the projector 211 according to the first embodiment, when the error in the scanning cycle of the light scanning devices 40 and 70 relative to the image forming cycle of the liquid crystal panels 62 and 262 is equal to or greater than a predetermined value, and when the error in the light emitting cycle of the light source device 230 relative to the image forming cycle of the liquid crystal panels 62 and 262 is equal to or greater than a predetermined value, the light modulation devices 60 and 260 do not emit the image light IL1 and IL2 and displays black.

According to the projector 211 of the first embodiment, it is possible to suppress the display of an unexpected image which is not based on the image information or the video information input to the drive control device 130.

In the projector 211 according to the first embodiment, when the error of the scanning cycle of the light scanning devices 40 and 70 with respect to the image forming cycle of the liquid crystal panels 62 and 262 of the light modulation devices 60 and 260 becomes equal to or greater than the predetermined value, the drive control device 130 changes the scanning cycle of the light scanning devices 40 and 70. The scanning cycle of the light scanning device 40 is determined by the rotation speed of the translucent members 42 and 76.

According to the projector 211 of the first embodiment, it is possible to smoothly maintain a synchronous state in which the light emitting cycle of the light source device 230, the scanning cycle of the light scanning devices 40 and 70, and the image forming cycle of the light modulation devices 60 and 260 are synchronized with each other, and to suppress deterioration in image quality over time.

In the projector 211 according to the first embodiment, when the error of the scanning cycle of the light scanning devices 40 and 70 with respect to the image forming cycle of the liquid crystal panels 62 and 262 of the light modulation devices 60 and 260 is equal to or greater than the predetermined value, the drive control device 130 changes the image forming cycle of the liquid crystal panels 62 and 262 of the light modulation devices 60 and 260.

According to the projector 211 of the first embodiment, even in the case of the control as described above, it is possible to smoothly maintain the synchronous state in which the light emitting cycle of the light source device 230, the scanning cycle of the light scanning devices 40 and 70, and the image forming cycle of the light modulation devices 60 and 260 are synchronized with each other and to suppress deterioration in image quality over time.

In the projector 211 according to the first embodiment, the modulation period TAL in which a three color light (first light) included in the color light WLP and WLS is modulated in the liquid crystal layers 68 and 268 of the liquid crystal panels 62 and 262 includes the above described leading-edge period T1 and constant period T2 and further includes the trailing-edge period T3 from the time when the modulation amount of the liquid crystal layers 68 and 268 is a predetermined value to the time when the modulation amount completely returns to the initial value.

The leading-edge period T1 represents a period from the leading-edge start time to the leading-edge completion time of the liquid crystal layers of the liquid crystal panels 62 and 262. The trailing-edge period T3 represents a period from the trailing-edge start time to the trailing-edge completion time of the liquid crystal layers of the liquid crystal panels 62 and 262. In the projector 211 according to the first embodiment, the color light WLP and WLS emitted from the light source device 230 is not incident on the light modulation devices 60 and 260 in a period overlapping with the trailing-edge period T3 of the other color regions in the constant period T2 in each color region of the liquid crystal panels 62 and 262 and in a period overlapping with the leading-edge period T1 of the other color regions in the constant period T2.

In the projector 211 according to the first embodiment, the modulation period TAL in each pixel of the liquid crystal panels 62 and 262 of the light modulation devices 60 and 260 include the leading-edge period (first period) T1, and the constant period (second period) T2, and the trailing-edge period (third period) T3. The leading-edge period T1 is a period from a time at which the modulation amount of the phases of the color light in the liquid crystal layers of the liquid crystal panels 62 and 262 starts to rise from the initial value to the predetermined value to a time at which it reaches the predetermined value. The constant period T2 is a period in which the modulation amount of the phases of the color light in the liquid crystal layers of the liquid crystal panels 62 and 262 is maintained constant at the predetermined value. The trailing-edge period T3 is a period from a time at which the modulation amount of the phase of the color light in the liquid crystal layers 68 and 268 of the liquid crystal panels 62 and 262 starts to fall from the predetermined value to the initial value to a time at which it reaches the initial value.

In the projector 211 according to the first embodiment, the color light WLP and WLS emitted from the light source device 230 and scanned in the first direction along the Y-axis and the Z-axis by the light scanning devices 40 and 70 is desirably incident on the liquid crystal panels 62 and 262 of the light modulation devices 60 and 260 in a period not overlapping the leading-edge period T1 or the trailing-edge period T3 of the green light (second color light) or the blue light (second color light) included in the color light WLP and WLS and having a wavelength band different from that of the red light in the constant period T2 of the red-color region R of the pixel for the red light (first color light) included in the color light WLP and WLS. Similarly, the color light WLP and WLS emitted from the light source device 230 is incident on the liquid crystal panels 62 and 262 in a period not overlapping the leading-edge period T1 or the trailing-edge period T3 of the blue light (second color light) or the red light (second color light) included in the color light WLP and WLS and having a wavelength band different from that of the green light in the constant period T2 of the green-color region G of the pixel for the green light (first color light). The color light WLP and WLS emitted from the light source device 230 is incident on the liquid crystal panels 62 and 262 during a period not overlapping the leading-edge period T1 or the trailing-edge period T3 of the red light (second color light) or the green light (second color light) included in the color light WLP and WLS and having a wavelength band different from that of the blue light in the constant period T2 of the blue-color region B of the pixel for the blue light (first color light).

That is, in the projector 211 according to the first embodiment, the color light WLP and WLS can be controlled not to enter the pixels in the leading-edge period T1 or the trailing-edge period T3 during the liquid crystal molecules of the liquid crystal layer rotate with respect to the red light, the green light, or the blue light and the modulation amount φ of the phase changes, among the plurality of pixels of the liquid crystal panels 62 and 262. In other words, either the above-described color light WLP or the above-described color light WLS is incident on, among the plurality of pixels of liquid crystal panels 62 and 262, the pixels that are in a period of the constant period T2 of the color light of the red light, the green light, or the blue light and that are not overlapping with the leading-edge period T1 and the trailing-edge period T3 of the other color light. The liquid crystal layer functions as a color filter by increasing or decreasing the modulation amount φ of the phase added to the color light WLP and WLS when the color light WLP and WLS is transmitted through the liquid crystal of the liquid crystal layer of each pixel of the liquid crystal panels 62 and 262, and a light intensity I and the light amount of the color light WLP and WLS transmitted through the liquid crystal layer increase or decrease. According to the projector 211 of the first embodiment controlled in this manner, the color of the input video is satisfactorily reproduced, and in addition to suppression of illuminance unevenness of the projection image on the projection surface, color mixture of the color light for display and the color light other than for display can be suppressed.

In the projector 211 according to the first embodiment, a polarization direction of the color light WLP and the polarization direction of the color light WLS are different from each other. The light source device 230 has the spatial light modulator 250 that alternately emits the color light WLP and the color light WLS by periodically changing the polarization state of the color light (light) WL emitted from the light emitting element 21.

According to the projector 211 of the first embodiment, it controls the polarization switching cycle in the spatial light modulator 250, thereby it is possible to easily switch the color light WLP of the P-polarization light and the color light WLS of the S-polarization light emitted from the light source device 230 alternately in time series.

The projector 211 according to the first embodiment further includes the polarizing separation element (first polarizing separation element) 310, the translucent member 42, the translucent member 76, and the polarizing separation element (second polarizing separation element) 320. The polarizing separation element 310 separates the color light WL emitted from the light source device 230 into the color light WLP and the color light WLS and emits the color light WLP and the color light WLS in different directions. The translucent member 42 periodically scans the color light WLP emitted from the polarizing separation element 310 and emits the color light WLP to the liquid crystal panel 62. The translucent member 76 periodically scans the color light WLS emitted from the polarizing separation element 310 and emits the color light WLS to the liquid crystal panel 262. The polarizing separation element 310 emits the image light (first image light) IL1 emitted from the liquid crystal panel 62 and the image light (second image light) emitted from the liquid crystal panel 262 in the same direction.

According to the projector 211 of the first embodiment, the color light WLP and WLS having different polarization directions is scanned and irradiated on the modulation surfaces 64 and 264 of the liquid crystal panels 62 and 262 by the translucent members 42 and 76, thereby the brightness of the projection image can be ensured.

### Modification of First Embodiment

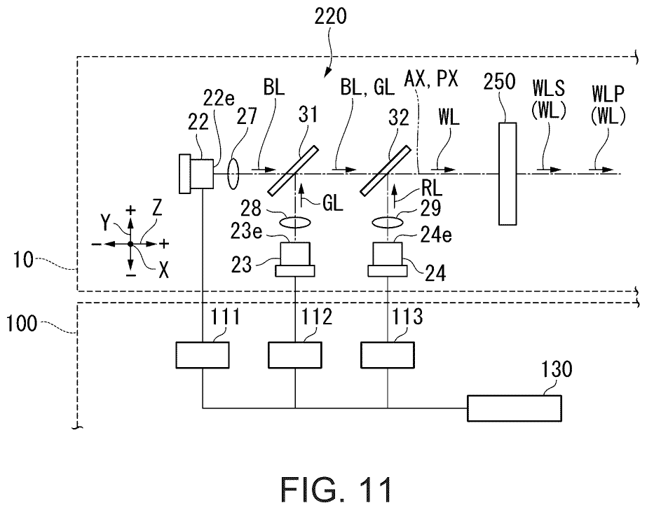

Next, a modification of the first embodiment of the present disclosure will be described with reference to FIG. 11. In a modification example of the first embodiment, the projector 211 may include a light source device 220 instead of the light source device 230.

FIG. 11 is a schematic view of the light source device 220. As shown in FIG. 11, the light source device 220 periodically emits the color light WLP and WLS. The light source device 220 includes a light emitting element 22 that emits the blue light BL, a light emitting element 23 that emits the green light GL, a light emitting element 24 that emits the red light RL, collimating lenses 27, 28, and 29, dichroic mirrors 31 and 32, and the spatial light modulator 250.

The light emitting element 22 emits the blue light BL from an emitting surface 22e to the +Z side along the Z-axis. The light emitting element 22 is, for example, a blue LD. The blue light BL is, for example, S-polarization light or P-polarization light.

The collimating lens 27 is disposed on an optical path of the blue light BL emitted from the light emitting element 22, is disposed at the same position as the emitting surface 22e of the light emitting element 22 in the X-axis and the Y-axis, and is disposed on the +Z side of the emitting surface 22e of the light emitting element 22. The central axis of the collimating lens 27 overlaps the optical axis of the blue light BL emitted from the light emitting element 22. The collimating lens 27 emits the blue light BL emitted from the light emitting element 22 along the optical axis AX as parallel light parallel to the Z-axis.

The collimating lens 27 is, for example, a biconvex lens. Note that the collimating lens 27 may be a plano-convex lens having a flat incident surface parallel to the XY plane and an emitting surface convex to the +Z side. Although the collimating lens 27 is disposed away from the emitting surface 22e of the light emitting element 22 in FIG. 11, the collimating lens 27 is a plano-convex lens, the collimating lens 27 may be in contact with the emitting surface 22e of the light emitting element 22.

The light emitting element 23 is disposed at the same position as the light emitting element 22 on the X-axis, is disposed on the −Y side of the light emitting element 22, and is disposed on the +Z side of the light emitting element 22 and on the −Z side of the translucent member 42 of the light scanning device 40. The light emitting element 23 emits the green light GL from the emitting surface 23e to the +Y side along the Y-axis. The light emitting element 23 is, for example, a green LD. The green light GL is, for example, S-polarization light or P-polarization light.

The collimating lens 28 is disposed on an optical path of the green light GL emitted from the light emitting element 23, is disposed at the same position as the emitting surface 23e of the light emitting element 23 in the X-axis and the Z-axis, and is disposed between the emitting surface 23e of the light emitting element 23 and the emitting surface 22e of the light emitting element 22 in the Y-axis. The central axis of the collimating lens 28 overlaps the optical axis of the green light GL emitted from the light emitting element 23 and intersects the central axis of the collimating lens 27. The collimating lens 28 emits the green light GL emitted from the light emitting element 23 to the +Y side as parallel light parallel to the Y-axis.

The collimating lens 28 is, for example, a biconvex lens. The collimating lens 28 may be a plano-convex lens having a flat incident surface parallel to the XZ plane including the X-axis and the Z-axis and an emitting surface convex to the +Y side. Although the collimating lens 28 is disposed away from the emitting surface 23e of the light emitting element 23 in FIG. 11, the collimating lens 28 is a plano-convex lens, the collimating lens 28 may be in contact with the emitting surface 23e of the light emitting element 23.

The light emitting element 24 is disposed at the same position as the light emitting elements 22 and 23 on the X-axis, is disposed on the −Y side of the light emitting element 22, and is disposed on the +Z side of the light emitting element 23 and on the −Z side of the translucent member 42 of the light scanning device 40. The light emitting element 24 emits the red light RL from the emitting surface 24e to the +Y side along the Y-axis. The light emitting element 24 is, for example, a red LD. The red light RL is, for example, the S-polarization light or the P-polarization light.

The collimating lens 29 is disposed in the optical path of the red light RL emitted from the light emitting element 24, is disposed at the same position as the emitting surface 24e of the light emitting element 24 in the X-axis and the Z-axis, and is disposed between the emitting surface 24e of the light emitting element 24 and the emitting surface 22e of the light emitting element 22 in the Y-axis. The central axis of the collimating lens 29 overlaps the optical axis of the red light RL emitted from the light emitting element 24 and intersects the central axis of the collimating lens 27. The collimating lens 29 emits the red light RL emitted from the light emitting element 24 to the +Y side as parallel light parallel to the Y-axis.

The collimating lens 29 is, for example, a biconvex lens. The collimating lens 29 may be a plano-convex lens having a flat incident surface parallel to the XZ plane including the X-axis and the Z-axis and an emitting surface convex to the +Y side. Although the collimating lens 29 is disposed away from the emitting surface 24e of the light emitting element 24 in FIG. 11, the collimating lens 29 is a plano-convex lens, the collimating lens 29 may be in contact with the emitting surface 24e of the light emitting element 24.

The dichroic mirror 31 is disposed in a region where the light path of the blue light BL emitted from the collimating lens 27 and the light path of the green light GL emitted from the collimating lens 28 overlap each other. A center of the dichroic mirror 31 in the XY plane substantially overlaps the intersection of the optical axis of the blue light BL emitted from the light emitting element 22 and the optical axis of the green light GL emitted from the light emitting element 23.

The dichroic mirror 31 has a reflection surface that transmits the blue light BL and reflects the green light GL. The reflecting surface of the dichroic mirror 31 inclines from the −Y side to the +Y side in accordance with movement from the −Z side to the +Z side as viewed along the X-axis. The blue light BL emitted from the collimating lens 27 is transmitted through the dichroic mirror 31 and is emitted to the +Z side along the Z-axis. The green light GL emitted from the collimating lens 28 is incident on the dichroic mirror 31, is reflected toward the +Z side along the Z-axis by the reflecting surface of the dichroic mirror 31, and is emitted in the same direction as the blue light BL.

The dichroic mirror 32 is disposed in a region where the light paths of the blue light BL and the green light GL emitted from the dichroic mirror 31 overlap the light path of the red light RL emitted from the collimating lens 29. A center of the dichroic mirror 32 in the XY plane substantially overlaps the intersection of the optical axis of the blue light BL emitted from the light emitting element 22 and the optical axis of the red light RL emitted from the light emitting element 24.

The dichroic mirror 32 has a reflection surface that transmits the blue light BL and the green light GL and reflects the red light RL. The reflecting surface of the dichroic mirror 32 inclines from the −Y side to the +Y side in accordance with movement from the −Z side to the +Z side as viewed along the X-axis. The blue light BL and the green light GL emitted from the dichroic mirror 32 are transmitted through the dichroic mirror 32 and emitted to the +Z side along the Z-axis. The red light RL emitted from the collimating lens 29 is incident on the dichroic mirror 32, is reflected toward the +Z side along the Z-axis by the reflecting surface of the dichroic mirror 32, and is emitted in the same direction as the blue light BL and the green light GL.

The blue light BL, the green light GL, and the red light RL emitted from the dichroic mirror 32 constitutes the color light WL, is emitted from the light source device 220 to the +Z side along the optical axis AX, and is incident on the spatial light modulator 250 as the color light WL. The behavior of the color light WLP and WLS emitted from the light source device 220 in the projector 211 is the same as the behavior of the color light WLP and WLS emitted from the light source device 230 in the projector 211.

In a modification of the first embodiment, light source output control devices 111, 112, and 113 may be provided as the light source output control device 110.

The light source output control device 111 is electrically connected to the light emitting element 22 of the light source device 220 in a wired or wireless manner and controls the light amount of the blue light BL emitted from the light emitting element 22. Specifically, the light source output control device 111 outputs an electrical signal related to a driving voltage or a driving current for controlling the light amount of the blue light BL emitted from the light emitting element 22 to the light emitting element 22 and causes the blue light BL to be periodically emitted from the light emitting element 22. The light source output control device 111 is, for example, an LD driver. A driver, which is the light source output control device 111, stores and saves a program of a periodic drive voltage value or drive current value to the light emitting element 22 corresponding to the elapsed time and the time t.

The light source output control device 112 is electrically connected to the light emitting element 23 of the light source device 220 in a wired or wireless manner and controls the light amount of the green light GL emitted from the light emitting element 23. Specifically, the light source output control device 112 outputs an electrical signal related to a driving voltage or a driving current for controlling the light amount of the green light GL emitted from the light emitting element 23 to the light emitting element 23 and causes the green light GL to be periodically emitted from the light emitting element 23. The light source output control device 112 is, for example, an LD driver. A driver, which is the light source output control device 112, stores and saves a program of a periodic drive voltage value or drive current value to the light emitting element 23 corresponding to the elapsed time and the time t.

The light source output control device 113 is electrically connected to the light emitting element 24 of the light source device 220 in a wired or wireless manner and controls the light amount of the red light RL emitted from the light emitting element 24. Specifically, the light source output control device 113 outputs an electrical signal related to a driving voltage or a driving current for controlling the light amount of the red light RL emitted from the light emitting element 24 to the light emitting element 24 and causes the red light RL to be periodically emitted from the light emitting element 24. The light source output control device 113 is, for example, an LD driver. A driver, which is the light source output control device 113, stores and saves a program of a periodic drive voltage value or drive current value to the light emitting element 24 corresponding to the elapsed time and the time t.

The drive control device 130 is electrically connected to the light source output control devices 111, 112, and 113 and the rotation control device 120 and is electrically connected to the liquid crystal panel 62 of the light modulation device 60 in a wired or wireless manner. The drive control device 130 outputs the electrical signals to the light source output control devices 111, 112, and 113 and the rotation control device 120, and controls the position, region, and timing at which the blue light BL emitted from the light emitting element 22, the green light GL emitted from the light emitting element 23, and the red light RL emitted from the light emitting element 24 of the light source device 220 are scanned as the color light WL by the translucent members 42 and 76 of the light scanning devices 40 and 70 and irradiated on the modulation surfaces 64 and 264 of the liquid crystal panels 62 and 262 of the light modulation devices 60 and 260. The drive control device 130 supplies an electrical signal to each pixel of the liquid crystal panels 62 and 262 on the modulation surfaces 64 and 264 in accordance with the irradiation position, the irradiation region, and the timing of the color light WL described above.

The above described light source output control devices 111, 112, and 113, the rotation control device 120, the drive control device 130, the central processing unit 140, the user interface 150, the video processing circuit 160, and the video interface 170 constitute the control section 100 of the projector 211.

### Second Embodiment

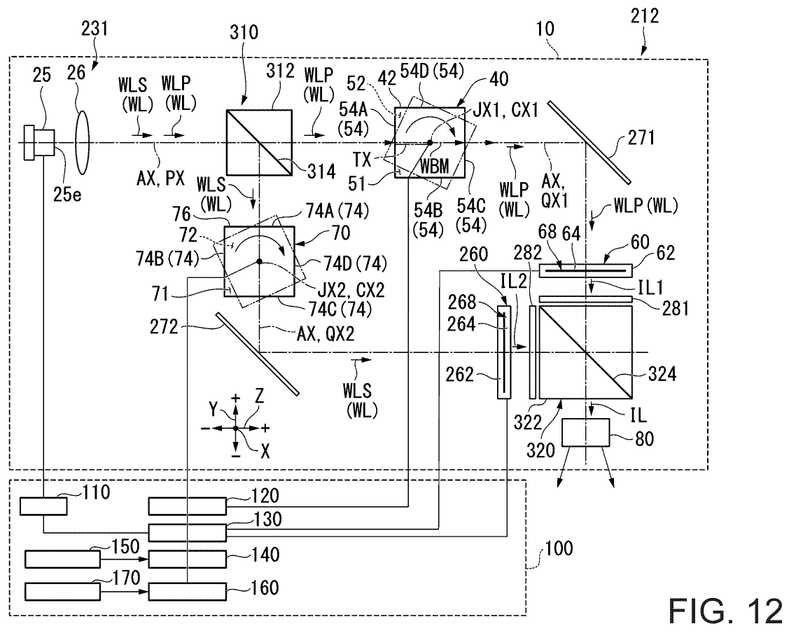

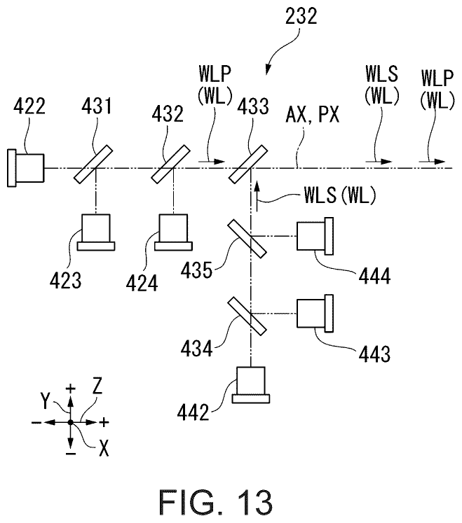

Next, a second embodiment of the present disclosure will be described with reference to FIG. 12 and FIG. 13. Note that in the following description of each embodiment, the description of the contents common to the first embodiment will be omitted, and only the contents different from the first embodiment will be described. Regarding the configuration of the projector of each embodiment, the same reference symbols as those of the corresponding configuration of the projector 201 of the first embodiment are given to the configuration common to the projector 201 of the first embodiment, and the description thereof will be omitted.

FIG. 12 is a schematic view of a projector 212 according to the second embodiment. As shown in FIG. 12, the projector 212 according to the second embodiment includes the light source device 231 instead of the light source device 230 of the projector 211 according to the first embodiment, and similarly includes other constituent elements other than the light source device 230. The light source device 231 includes a light emitting element 25 instead of the light emitting element 21 and does not include the spatial light modulator 250. The light emitting element 25 receives the electrical signal from the light source output control device 110 and alternately emits the color light WLP and WLS from an emitting surface 25e in time series. The light source device 231 alternately emits the color light WLP and WLS, which is parallel light, to the +Z side along the Z-axis in time series.

The projector 212 according to the above described second embodiment has the same configuration as the projector 211 according to the first embodiment, and thus has the same operational effects as the projector 211 according to the first embodiment.

### Modification of Second Embodiment

The projector according to the modification of the second embodiment may include a light source device 232 instead of the light source device 231. FIG. 13 is a schematic view of the light source device 232 of the modification of the second embodiment. As shown in FIG. 13, in the light source device 232, the red light of the P-polarization light emitted from a light emitting element 422 is transmitted through dichroic mirrors 431, 432, and 433 as the color light WL, and emitted to the +Z side. The green light of the P-polarization light emitted from a light emitting element 423 is reflected by the dichroic mirror 431 as the color light WL, transmitted through the dichroic mirrors 432 and 433, and emitted to the +Z side. The blue light of the P-polarization light emitted from a light emitting element 424 is reflected by the dichroic mirror 432 as the color light WL, transmitted through the dichroic mirror 433, and emitted to the +Z side.

In the light source device 232, the red light of the S-polarization light emitted from the light emitting element 442 is transmitted through the dichroic mirrors 434 and 435 as the color light WL, reflected by the dichroic mirror 433, and emitted to the +Z side. The green light of the S-polarization light emitted from a light emitting element 443 is reflected by the dichroic mirror 434 as the color light WL, transmitted through the dichroic mirror 435, reflected by the dichroic mirror 433, and emitted to the +Z side. The blue light of the P-polarization light emitted from a light emitting element 444 is reflected by the dichroic mirrors 435 and 433 as the color light WL and emitted to the +Z side.

### Third Embodiment

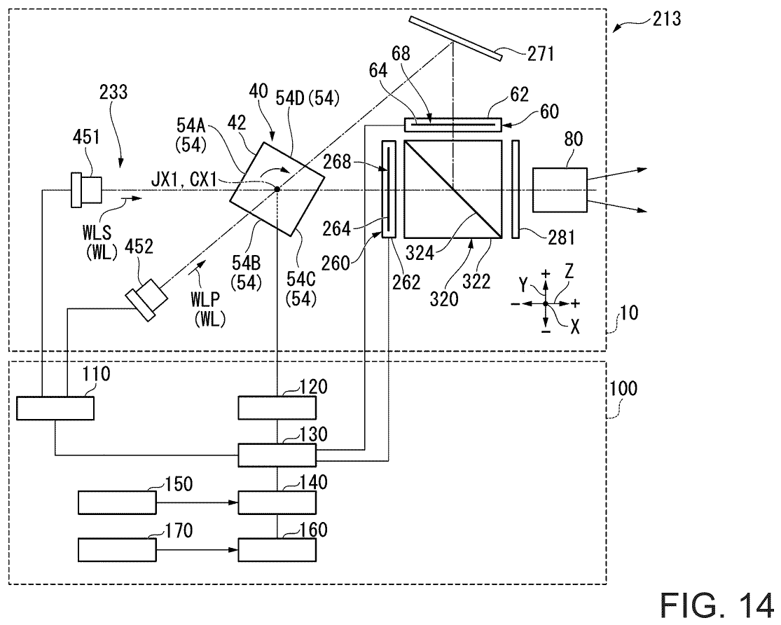

Next, a third embodiment of the present disclosure will be described with reference to FIG. 14. FIG. 14 is a schematic view of a projector 213 according to the third embodiment. As shown in FIG. 14, the projector 213 includes the optical section 10 and the control section 100. Specifically, the optical section 10 of the projector 213 includes a light source device 233, the light scanning device 40, the reflective element 271, the light modulation devices 60 and 260, the polarizing separation element 320, and the projection optical system 80.

The projector 213 according to the third embodiment includes only one light scanning device 40. A light emitting element 451 of the light source device 233 irradiates one side surface 54 of the translucent member 42 of the light scanning device 40 with the color light WLS of the S-polarization light. The light emitting element 452 of the light source device 233 irradiates the color light WLP of the P-polarization light on the side surface 54 different from the one side surface 54 of the translucent member 42 of the light scanning device 40. In the projector 213 according to the third embodiment, only one light scanning device 40 is used, thereby achieving miniaturization.

The projector 213 according to the third embodiment described above includes the same configuration as the projector 211 according to the first embodiment, and thus has the same operational effects as the projector 211 according to the first embodiment. The light source device 233 may be configured as in the modification example referred to in FIG. 13 and the like.

Although the preferred embodiments of the present disclosure have been described in detail above, the present disclosure is not limited to the specific embodiments, and various modifications and changes can be made within the scope of the gist of the present disclosure described in the claims. Further, the constituent elements of the plurality of embodiments can be appropriately combined.

For example, although not shown, the projector according to the present embodiment is not limited to the projector including the light scanning devices 40 and 70 that scan the color light WL toward the light modulation devices 60 and 260, and may be a surface uniform illumination type projector.

### Summary of Present Disclosure

Hereinafter, a summary of the present disclosure is appended.

Appendix 1. A projector includes a light source device configured to periodically emit illumination light including a first light and a second light; a light modulation device configured to modulate the illumination light emitted from the light source device in accordance with image information; and a projection optical system configured to project image light emitted from the light modulation device, wherein the light source device has a light emitting element configured to emit the first light and the second light, the light modulation device has a first liquid crystal element configured to form an image by converting the first light incident thereon into a first image light in accordance with the image information input thereto and a second liquid crystal element configured to form an image by converting the second light incident thereon into a second image light in accordance with the image information input thereto, an irradiation cycle of the first light irradiated from the light source device and irradiated on the first liquid crystal element and an image forming cycle of the first liquid crystal element are synchronized with each other, an irradiation cycle of the second light irradiated from the light source device and irradiated on the second liquid crystal element and an image forming cycle of the second liquid crystal element are synchronized with each other, the image forming cycle of the first liquid crystal element and the image forming cycle of the second liquid crystal element are shifted from each other, and a wavelength of the first light incident on the first liquid crystal element and a wavelength of the second light incident on the second liquid crystal element are different from each other.

According to the configuration of Appendix 1, in a two-panel time-division color projector, the timing of light emission of the light source device, the output cycle, and the image forming cycle of each of the first liquid crystal element and the second liquid crystal element of the light modulation device are synchronized, and the image formation time periods of the first liquid crystal element and the second liquid crystal element are made different from each other, thereby suppressing the occurrence of color breakup in the projection image.

Appendix 2. The projector according to Appendix 1, further includes a light scanning device configured to periodically scan the illumination light emitted from the light source device and emit the illumination light to the light modulation device.

According to the configuration of Appendix 2, the scanning cycle of the light scanning device that scans the illumination light emitted from the light source device is synchronized with the light emission timing and the output cycle of the light source device and the image forming cycle of each of the first liquid crystal element and the second liquid crystal element of the light modulation device, and thus it is possible to suppress the occurrence of illuminance unevenness in the projection image.

Appendix 3. The projector according to Appendix 2, wherein the light scanning device has a transmissive optical element that is configured to scan the illumination light along a first direction and that has an incident surface on which the first light emitted from the light source device is incident and an emitting surface from which the first light incident from the incident surface is emitted and the transmissive optical element has a first surface parallel to the first direction and 2×m second surfaces in contact with the first surface.

According to the configuration of Appendix 3, the first light scanned by the light scanning device and emitted from the light scanning device can be emitted in parallel to the principal ray of the first light incident on the light scanning device.

Appendix 4. The projector according to any one of Appendix 1 to Appendix 3, wherein the first liquid crystal element has a first liquid crystal layer in which a modulation amount with respect to the first light changes according to an electrical signal having the image information that was input, the second liquid crystal element has a second liquid crystal layer in which a modulation amount with respect to the second light changes according to an electrical signal having the image information that was input, a modulation period of the first liquid crystal layer and a modulation period of the second liquid crystal layer include a first period from a time at which the electrical signal is input to a time at which a modulation amount reaches a predetermined value and a second period during which the modulation amount is maintained at the predetermined value, and the illumination light emitted from the light source device is incident on the first liquid crystal element and the second liquid crystal element in the second period.

According to the configuration of Appendix 4, the illumination light emitted from the light source is incident on the second period of the first liquid crystal layer of the first liquid crystal element, and the illumination light is incident on the second period of the second liquid crystal layer of the second liquid crystal element, which is shifted from the second period of the first liquid crystal layer, thereby suppressing the occurrence of illuminance unevenness in the projection image.

Appendix 5. The projector according to Appendix 4, wherein a time period of the first period of the first liquid crystal element is included in a time period of the second period of the second liquid crystal element and the illumination light is incident on the second liquid crystal element in a time period in which the first period and the second period overlap each other.

According to the configuration of Appendix 5, the first period for the color light of the first liquid crystal element overlaps with the constant period for the other color light of the second liquid crystal element, and the illumination light is incident on the second liquid crystal element without being incident on the first liquid crystal element, and thus it is possible to suppress the occurrence of illuminance unevenness and color break-up in the projection image.

Appendix 6. The projector according to Appendix 4, further includes a drive control device configured to transmit the electrical signal to the light modulation device, wherein the drive control device is configured to transmit a synchronization signal based on the electrical signal to the light source device.

According to the configuration of Appendix 6, it is possible to easily synchronize the power, the light emitting cycle, or the output cycle of the illumination light emitted from the light source device with the image forming cycle in the light modulation device using the drive control device.

Appendix 7. The projector according to Appendix 2 or Appendix 3, further includes a drive control device configured to transmit the electrical signal to the light modulation device, wherein the drive control device is configured to transmit a synchronization signal based on the electrical signal providing the image information to the light source device and the light scanning device.

According to the configuration of Appendix 7, it is possible to easily synchronize the power, the light emitting cycle, or the output cycle of the illumination light emitted from the light source device, the scanning cycle of the light scanning device, and the image forming cycle in the light modulation device, using the drive control device.

Appendix 8. The projector according to any one of Appendix 1 to Appendix 7, wherein the light modulation device does not emit the image light when both an error of a scanning cycle of the light scanning device with respect to an image forming cycle of the light modulation device is equal to or greater than a predetermined value and also an error of a light emitting cycle of the light source device with respect to the image forming cycle of the light modulation device is equal to or greater than a predetermined value.

According to the configuration of Appendix 8, it is possible to suppress unexpected display that is not based on the image information or the video information of a projection target input to the drive control device in a projection image.

Appendix 9. The projector according to any one of Appendix 1 to Appendix 7, wherein when an error of a scanning cycle of the light scanning device with respect to an image forming cycle of the light modulation device becomes equal to or greater than a predetermined value, the drive control device changes the scanning cycle of the light scanning device.

According to the configuration of Appendix 9, it is possible to smoothly maintain a synchronous state in which the light emitting cycle of the light source device, the scanning cycle of the light scanning device, and the image forming cycle of the light modulation device are synchronized with each other, and to suppress a decrease in image quality over time.

Appendix 10. The projector according to any one of appendix 1 to Appendix 9, wherein when an error of a scanning cycle of the light scanning device with respect to an image forming cycle of the light modulation device becomes equal to or greater than a predetermined value, the drive control device changes the image forming cycle of the light modulation device.

According to the configuration of Appendix 10, it is possible to smoothly maintain the synchronous state and suppress a decrease in image quality over time.

Appendix 11. The projector according to Appendix 4, wherein the modulation period further includes a third period from a time when the modulation amount is the predetermined value to a time when it reaches an initial value and the first light emitted from the light source device is incident on the light modulation device during a period that is during the second period for a first color light included in the first light and that does not overlap with the first period or the third period for a second color light having a different wavelength band from the first color light included in the first light.

According to the configuration of Appendix 11, the color of the image included in the image information or the video information input from the drive control device or the like to the light modulation device is satisfactorily reproduced, and it is possible to suppress color mixture of the color light for display and the color light other than for display in addition to illuminance unevenness in the projection image.

Appendix 12. The projector according to any one of Appendix 1 to Appendix 3, wherein a polarization direction of the first light and a polarization direction of the second light are different from each other and the light source device has a spatial light modulator configured to alternately emit the first light and the second light by periodically changing a polarization state of light emitted from the light emitting element.

According to the configuration of the Appendix 12, it is possible to control the polarization switching cycle of the first light and the second light in the spatial light modulator, and easily switch the first light and the second light emitted from the light source device in time series.

Appendix 13. The projector according to Appendix 12, further including a first polarizing separation element configured to separate the illumination light emitted from the light source device into the first light and the second light and emit the first light and the second light in different directions; a first transmissive optical element configured to periodically scan the first light emitted from the first polarizing separation element and emit the first light to the first liquid crystal element; a second transmissive optical element configured to periodically scan the second light emitted from the first polarizing separation element and emit the second light to the second liquid crystal element; and a second polarizing separation element configured to emit the first image light emitted from the first liquid crystal element and the second image light emitted from the second liquid crystal element in the same direction.

According to the configuration of Appendix 13, the first light the second light having polarization directions different from each other are scanned and irradiated on the modulation surfaces of the first liquid crystal element and the second liquid crystal element of the light modulation device by the first transmissive optical element and the second transmissive optical element, and thus it is possible to secure the brightness of the projection image.

Appendix 14. The projector according to any one of Appendix 1 to Appendix 3, wherein the light source device has a first light emitting element configured to periodically emit the first light and a second light emitting element configured to periodically emit the second light and a light scanning device configured to periodically scan the first light and the second light that is emitted from the first light emitting element and the second light emitting element and that enters at different angles and to emit the first light and the second light to the light modulation device and a reflective element configured to reflect one type of light of the first light and the second light emitted from the light scanning device and cause the one type of light to fall incident on the first liquid crystal element or the second liquid crystal element that corresponds to the one type of light.

According to the configuration of Appendix 14, the first light irradiated from the first light emitting element and the second light irradiated from the second light emitting element are scanned by one light scanning device and are irradiated on the modulation surfaces of the first liquid crystal element and the second liquid crystal element, and thus it is possible to achieve a reduction in size of the projector.

What is claimed is:

1. A projector comprising:
a light source device configured to periodically emit illumination light including a first light and a second light;
a light modulation device configured to modulate the illumination light emitted from the light source device in accordance with image information; and
a projection optical system configured to project image light emitted from the light modulation device, wherein
the light source device has a light emitting element configured to emit the first light and the second light,
the light modulation device has
a first liquid crystal element configured to form an image by converting the first light incident thereon into a first image light in accordance with the image information input thereto and
a second liquid crystal element configured to form an image by converting the second light incident thereon into a second image light in accordance with the image information input thereto,
an irradiation cycle of the first light irradiated from the light source device and irradiated on the first liquid crystal element and an image forming cycle of the first liquid crystal element are synchronized with each other,
an irradiation cycle of the second light irradiated from the light source device and irradiated on the second liquid crystal element and an image forming cycle of the second liquid crystal element are synchronized with each other,
the image forming cycle of the first liquid crystal element and the image forming cycle of the second liquid crystal element are shifted from each other, and
a wavelength of the first light incident on the first liquid crystal element and a wavelength of the second light incident on the second liquid crystal element are different from each other.

2. The projector according to claim 1, further comprising:
a light scanning device configured to periodically scan the illumination light emitted from the light source device and emit the illumination light to the light modulation device.

3. The projector according to claim 2, wherein
the light scanning device has a transmissive optical element that is configured to scan the illumination light along a first direction and that has an incident surface on which the first light emitted from the light source device is incident and an emitting surface from which the first light incident from the incident surface is emitted and
the transmissive optical element has
a first surface parallel to the first direction and 2×m second surfaces in contact with the first surface, m being a natural number equal to or greater than 2.

4. The projector according to claim 1, wherein
the first liquid crystal element has a first liquid crystal layer in which a modulation amount with respect to the first light changes according to an electrical signal having the image information that was input,
the second liquid crystal element has a second liquid crystal layer in which a modulation amount with respect to the second light changes according to an electrical signal having the image information that was input,
a modulation period of the first liquid crystal layer and a modulation period of the second liquid crystal layer include a first period from a time at which the electrical signal is input to a time at which a modulation amount reaches a predetermined value and a second period during which the modulation amount is maintained at the predetermined value, and
the illumination light emitted from the light source device is incident on the first liquid crystal element and the second liquid crystal element in the second period.

5. The projector according to claim 4, wherein
a time period of the first period of the first liquid crystal element is included in a time period of the second period of the second liquid crystal element and
the illumination light is incident on the second liquid crystal element in a time period in which the first period and the second period overlap each other.

6. The projector according to claim 4, further comprising:
a drive control device configured to transmit the electrical signal to the light modulation device, wherein
the drive control device is configured to transmit a synchronization signal based on the electrical signal to the light source device.

7. The projector according to claim 2, further comprising:
a drive control device configured to transmit an electrical signal providing the image information to the light modulation device, wherein
the drive control device is configured to transmit a synchronization signal based on the electrical signal to the light source device and the light scanning device.

8. The projector according to claim 2, wherein
the light modulation device does not emit the image light when both an error of a scanning cycle of the light scanning device with respect to an image forming cycle of the light modulation device is equal to or greater than a predetermined value and also an error of a light emitting cycle of the light source device with respect to the image forming cycle of the light modulation device is equal to or greater than a predetermined value.

9. The projector according to claim 7, wherein
when an error of a scanning cycle of the light scanning device with respect to an image forming cycle of the light modulation device becomes equal to or greater than a predetermined value, the drive control device changes the scanning cycle of the light scanning device.

10. The projector according to claim 7, wherein
when an error of a scanning cycle of the light scanning device with respect to an image forming cycle of the light modulation device becomes equal to or greater than a predetermined value, the drive control device changes the image forming cycle of the light modulation device.

11. The projector according to claim 4, wherein
the modulation period further includes a third period from a time when the modulation amount is the predetermined value to a time when it reaches an initial value and
the first light emitted from the light source device is incident on the light modulation device during a period that is during the second period for a first color light included in the first light and that does not overlap with the first period or the third period for a second color light having a different wavelength band from the first color light included in the first light.

12. The projector according to claim 1, wherein
a polarization direction of the first light and a polarization direction of the second light are different from each other and
the light source device has a spatial light modulator configured to alternately emit the first light and the second light by periodically changing a polarization state of light emitted from the light emitting element.

13. The projector according to claim 12, further comprising:
a first polarizing separation element configured to separate the illumination light emitted from the light source device into the first light and the second light and emit the first light and the second light in different directions;
a first transmissive optical element configured to periodically scan the first light emitted from the first polarizing separation element and emit the first light to the first liquid crystal element;
a second transmissive optical element configured to periodically scan the second light emitted from the first polarizing separation element and emit the second light to the second liquid crystal element; and
a second polarizing separation element configured to emit the first image light emitted from the first liquid crystal element and the second image light emitted from the second liquid crystal element in the same direction.

14. The projector according to claim 1, wherein
the light source device has
a first light emitting element configured to periodically emit the first light and
a second light emitting element configured to periodically emit the second light and
the projector further includes
a light scanning device configured to periodically scan the first light and the second light that is emitted from the first light emitting element and the second light emitting element and that enters at different angles and to emit the first light and the second light to the light modulation device and
a reflective element configured to reflect one type of light of the first light and the second light emitted from the light scanning device and cause the one type of light to fall incident on the first liquid crystal element or the second liquid crystal element that corresponds to the one type of light.
